(19) United States
(12) Patent Application Publication
(10) Pub. No.: US 2024/0396227 A1
(43) Pub. Date: Nov. 28, 2024

(54) ANTENNA MODULE HAVING ANTENNA IN MOLD LAYER, AND RELATED FABRICATION METHODS

(71) Applicant: QUALCOMM Incorporated, San Diego, CA (US)

(72) Inventors: Chien-Te Feng, San Diego, CA (US); Jay Scott Salmon, San Diego, CA (US); Wen Yin, San Diego, CA (US)

(21) Appl. No.: 18/324,114

(22) Filed: May 25, 2023

(51) Int. Cl. H01Q 21/00; H01Q 1/22; H01Q 1/38

(52) U.S. Cl. CPC H01Q 21/0087; H01Q 1/2283; H01Q 1/38

(57) ABSTRACT

An antenna module having an antenna in a mold layer, and related fabrication methods are disclosed. The antenna module includes a substrate that supports one or more semiconductor dies (“dies”). The die(s) can include radio-frequency (RF) circuits. A mold layer is formed over the die(s) and the package substrate to insulate and protect the die(s). The antenna is electrically coupled to the die(s). In exemplary aspects, an antenna (e.g., an antenna patch, waveguide, and/or dipole antenna elements) is provided in the mold layer. For example, the antenna can be formed in the mold layer adjacent to the die(s), wherein the antenna is electrically coupled to the die(s) through the substrate. In this manner, the mold layer can be provided having a desired dielectric constant to achieve better attenuation characteristics for the antenna to meet the performance requirements for supporting higher frequencies as an example.

### BACKGROUND

### I. Field of the Disclosure

The field of the disclosure relates to antenna modules, such as “antenna-in-packages” (AiP(s)), that include a radio-frequency (RF) integrated circuit (IC) coupled to an antenna(s) as part of an IC package.

### II. Background

Modern smart phones and other portable devices have extended the use of different wireless links with a variety of technologies in different radio frequency (RF) bands. For example, fifth generation (5G) cellular networks, commonly referred to as 5G new radio (NR), include frequencies in the range of 24.25 to 86 Giga Hertz (GHz), with the lower 19.25 GHz (24.25-43.5 GHz) more likely to be used for mobile devices. This frequency spectrum of 5G communications is in the range of millimeter wave (mmWave) or millimeter band. mmWave enables higher data rates than at lower frequencies, such as those used for Wi-Fi and current cellular networks. It may also be desired to provide for communication devices that support higher communications frequencies that are sub-mm Wave for a sixth generation (6G) frequency spectrum, such as the D-band frequency spectrum in the frequency range of 110 GHz to 170 GHz, to utilize an additional available frequency spectrum.

RF transceivers are incorporated into mobile and other portable devices that are designed to support communications signals in the desired frequency spectrum. To support the integration of a RF transceiver in a device, the RF transceiver can be integrated in a RF integrated circuit (IC) in a RF IC chip that is provided as part of an antenna module or it can be disaggregated into multiple RF IC chips. The RF IC chip is realized in a RF IC semiconductor die (“RF IC die”). An antenna module may also be referred to as an “antenna-in-package” (AiP). A conventional antenna module includes a die module that includes one or more RF ICs, a power management IC (PMIC), and passive electrical components (e.g., inductors, capacitors, etc.) mounted to a package substrate as a support structure. The RF IC die includes a RF signal transmitter and receiver capable of modulating RF signals to be transmitted in a supported frequency band(s) and demodulating received RF signals in a supported frequency band(s). The package substrate includes a plurality of metallization layers (e.g., laminated FR2 metallization layers) that include metal lines/traces to metal interconnects for providing chip-to-chip and external signal interfaces to the die module. The package substrate also includes other metallization layers wherein one or more antennas are formed that are electrically coupled to the die module through the metal interconnects of the package substrate to be capable of receiving and radiating electrical RF signals as electromagnetic (EM) signals. The package substrate may include a plurality of antennas, also referred to as an antenna array, to provide signal coverage in a desired, larger area around the antenna module.

As the frequency spectrum supported by antenna modules increases, there is a need to design antennas in such antenna modules to be capable of supporting higher frequencies, such as D-band frequencies for example. Antenna designers utilize various physical attributes within an antenna module when designing antennas to meet various frequency spectrums including, but not limited to, spacing of antenna elements, size of antenna elements, shielding of RF IC dies, and dielectric constants of insulators between antenna components.

### SUMMARY

Aspects disclosed in the detailed description include an antenna module with an antenna in a mold layer of the antenna module. Related fabrication methods are also disclosed. The antenna module includes a package substrate (“substrate”) that supports one or more semiconductor dies (“dies”) and provides a routing structure with metallization layers to provide signal routing paths to the die(s). The die(s) can include radio-frequency (RF) circuits to support processing of transmitted and received radio frequencies. A mold layer is formed over the die(s) and the substrate to insulate and protect the die(s). The antenna module also includes an antenna that is electrically coupled to the die(s). In exemplary aspects, an antenna (e.g., an antenna patch, waveguide, and/or dipole antenna elements) for the antenna module is provided in the mold layer that surrounds the die(s). For example, the antenna can be formed in the mold layer adjacent to the die(s), wherein the antenna is electrically coupled to the die(s) through the substrate. In this manner, an area within the mold layer that is not otherwise consumed by the die(s) or other components can be advantageously used to support an antenna for the antenna module. For example, this may avoid the need for separate antenna layers to be formed on the substrate (e.g., on the opposite side of the die(s)) to provide the antenna, which would otherwise add to the total height of the antenna module. It may be important to provide for the antenna module to consume a small width so that the antenna module can be more easily incorporated in smaller electronic devices that have limited area available for an antenna module. Insulation layers in the substrate contain a glass weave in order to provide structural support. The glass weave limits the desired dielectric constant an antenna designer may want to achieve. The mold layer, as described herein, either has much less glass weave than the substrate or no glass weave at all depending on the height of the antenna module. In this regard, the antenna module described here may use one or more mold layers composed of a wider variety of dielectric material than in a substrate. The mold layer can be provided having a desired dielectric constant to achieve better attenuation characteristics for the antenna to meet the performance requirements for supporting higher frequencies as an example. Also, providing the antenna in the mold layer may provide more flexibility to form metal layers and components therein and with the desired pitch and spacing to form the antenna that may be more difficult in the substrate to avoid interfering with other signal routing paths therein.

In another exemplary aspect, fabrication processes are provided to fabricate an antenna module that includes an antenna provided in the mold layer. For example, in one exemplary fabrication process, a mold cavity-type fabrication process is provided. The mold cavity-type fabrication process can include patterning openings in a mold layer to then dispose a metal material in the openings to form the antenna elements of the antenna. As an example, the mold cavity-type fabrication process can include the steps of patterning cavities in the mold layer, disposing a metal layer on the mold layer wherein the metal material of the metal layer is disposed in the cavities, and then grinding away excess metal of the metal layer outside the cavities leaving metal in the cavities to form the antenna elements. The mold cavity-type fabrication process may be used when the desired metal pattern has a low metal density as an example. An exemplary mold slot-type fabrication process can include first disposing a metal layer of metal material on a mold layer and then patterning and forming openings in the metal layer to remove the metal material in the openings. The residual metal material outside the openings formed in the mold layer can be antenna elements of the antenna. As an example, the mold slot-type fabrication process can include the steps of sputtering metal over the surface of the mold layer and utilizing a laser to form a pattern of slots in the sputtered metal. Both of these processes may be used for a particular antenna module. For example, the mold slot-type process may be used when the desired metal pattern at a particular mold layer has high metal density. The mold cavity-type process may be used when the desired metal pattern at a particular mold layer is not as high. When fabricating an antenna module either the mold slot-type process or the cavity-type process may be used on a mold layer-by-layer basis.

These fabrications processes can also be repeated to form metal patterns on a plurality of metal layers to form antenna elements at multiple vertical levels within the mold layer. Utilizing fabrication processes based on metal density on a particular metal layer advantageously increases throughput of antenna module manufacturing.

The same fabrication processes used to pattern metal in the mold layer to form an antenna are also used to form a metal shield for the die(s) in the antenna module. By leveraging the same fabrication process for different metal components (e.g., antennas and shields) in the antenna module, manufacturing costs are advantageously reduced.

In this regard, in one exemplary aspect, an antenna module comprises a substrate extending in a first direction and a die comprising a radio-frequency (RF) circuit. The die is disposed on the substrate. The antenna module also comprises a first mold layer including the die and adjacent the substrate in a second direction orthogonal to the first direction. The first mold layer has a first surface and a first antenna. The first antenna comprises a first antenna element adjacent to the first surface of the first mold layer in the second direction. The RF circuit is electrically coupled to the first antenna.

In another exemplary aspect, a method of fabricating an antenna module comprises forming a substrate extending in a first direction and coupling a die on the substrate. The die comprises a radio-frequency (RF) circuit. The method also comprises applying a first mold layer on the die and the substrate. The first mold layer adjacent the substrate in a second direction orthogonal to the first direction. The first mold layer has a first surface. The method also comprises forming a first antenna comprising a first antenna element adjacent to the first surface of the first mold layer in the second direction; and electrically coupling the RF circuit to the first antenna.

### BRIEF DESCRIPTION OF THE DRAWINGS

FIG. 1A is a side view of an exemplary antenna module having an antenna and a die in a mold layer wherein the mold layer has a desired dielectric constant to achieve better attenuation characteristics for the antenna and fabricated utilizing a mold cavity-type process;

FIG. 1B is a side view of the exemplary antenna module in FIG. 1A taken at cut lines A1-A1′ of FIG. 1C and illustrating alternative embodiments for the metal post in FIG. 1A;

FIG. 1C is a top view from the Z-axis direction illustrating an exemplary arrangement of antenna elements in the first set of antenna elements of FIG. 1A.

FIG. 2 is a side view of another exemplary antenna module having an antenna and a die in a mold layer wherein the mold layer has a desired dielectric constant to achieve better attenuation characteristics for the antenna and wherein the antenna is electrically coupled to the die through a substrate through antenna feed lines connecting the die with the antenna;

FIG. 3 is a side view of another exemplary antenna module having an antenna and a die in a mold layer wherein the mold layer has a desired dielectric constant to achieve better attenuation characteristics for the antenna and wherein antenna portions are vertically shielded;

FIG. 4 is a side view of another exemplary antenna module having an antenna and a die in a mold layer wherein the mold layer has a desired dielectric constant to achieve better attenuation characteristics for the antenna and wherein both sets of antenna elements are deployed on a respective mold layer and layers of metal shielding of a die are also deployed on respective mold layers;

FIG. 5 is a side view of an exemplary antenna module having an antenna and a die in a mold layer wherein the mold layer has a desired dielectric constant to achieve better attenuation characteristics for the antenna and fabricated utilizing a mold slot-type process;

FIG. 6 is a side view of an exemplary antenna module having an antenna and multiple dies in a mold layer wherein the mold layer has a desired dielectric constant to achieve better attenuation characteristics for the antenna, and fabricated utilizing a mold slot-type process;

FIG. 7 is a side view of an exemplary antenna module having an antenna and a die in a mold layer wherein the mold layer has a desired dielectric constant to achieve better attenuation characteristics for the antenna, wherein first and second sets of antenna elements are disposed on respective mold layers, and fabricated utilizing a mold slot-type process;

FIG. 8 is a flowchart illustrating an exemplary fabrication process of fabricating an antenna module having an antenna and a die in a mold layer wherein the mold layer has a desired dielectric constant to achieve better attenuation characteristics for the antenna, including, but not limited to, the antenna modules in FIGS. 1A-7;

FIGS. 9A-9D-2 is a flowchart illustrating an exemplary mold cavity-type fabrication process for fabricating an antenna module having an antenna and a die in a mold layer wherein the mold layer has a desired dielectric constant to achieve better attenuation characteristics for the antenna;

FIGS. 10A-10F-2 are exemplary fabrication stages during fabrication of the antenna module according to the fabrication process in FIGS. 9A-9D-2;

FIGS. 11A-11B is a flowchart illustrating an exemplary mold slot-type fabrication process for fabricating an antenna module having an antenna and a die in a mold layer wherein the mold layer has a desired dielectric constant to achieve better attenuation characteristics for the antenna;

FIGS. 12A-12C are exemplary fabrication stages during fabrication of the antenna module according to the fabrication process in FIGS. 11A-11B;

FIG. 13 is a block diagram of an exemplary wireless communication device that includes radio-frequency (RF) components that can include an antenna module having an antenna and a die in a mold layer wherein the mold layer has a desired dielectric constant to achieve better attenuation characteristics for the antenna including, but not limited to, the antenna modules in FIGS. 1A-7 and according to, but not limited to, any of the exemplary fabrication processes in FIGS. 8, 9A-9D-2, and 11A-11B; and

FIG. 14 is a block diagram of an exemplary processor-based system that can include an antenna module having an antenna and a die in a mold layer wherein the mold layer has a desired dielectric constant to achieve better attenuation characteristics for the antenna including, but not limited to, the antenna modules in FIGS. 1A-7 and according to, but not limited to, any of the exemplary fabrication processes in FIGS. 8, 9A-9D-2, and 11A-11B.

FIGS. 15A-15D are block diagrams of exemplary deployments of antenna modules having an antenna in a mold layer on a printed circuit board wherein the mold layer has a desired dielectric constant to achieve better attenuation characteristics for the antenna including, but not limited to, the antenna modules in FIGS. 1A-7 and according to, but not limited to, any of the exemplary fabrication processes in FIGS. 8, 9A-9D-2, and 11A-11B. FIGS. 15A, 15B, 15C, and 15D illustrate individual exemplary deployments that are shown deployed on the same printed circuit board.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include an antenna module with an antenna in a mold layer of the antenna module. Related fabrication methods are also disclosed. The antenna module includes an antenna substrate (“substrate”) that supports one or more semiconductor dies (“dies”) and provides a routing structure with metallization layers to provide signal routing paths to the die(s). The die(s) can include radio-frequency (RF) circuits to support processing of transmitted and received radio frequencies. A mold layer is formed over the die(s) and the package substrate to insulate and protect the die(s). The antenna module also includes an antenna that is electrically coupled to the die(s). In exemplary aspects, an antenna (e.g., an antenna patch, waveguide, and/or dipole antenna elements) for the antenna module is provided in the mold layer that surrounds the die(s). For example, the antenna can be formed in the mold layer adjacent to the die(s), wherein the antenna is electrically coupled to the die(s) through the package substrate. In this manner, area within the mold layer that is not otherwise consumed by the die(s) or other components can be advantageously used to support an antenna for the antenna module. For example, this may avoid the need for separate antenna layers to be formed on the package substrate (e.g., on the opposite side of the die(s)) to provide the antenna, which would otherwise add to the total height of the antenna module. It may be important to provide for the antenna module to consume a small width so that the antenna module can be more easily incorporated in smaller electronic devices that have limited area available for an antenna module. Also, since the mold layer can be composed of a wider variety of dielectric material than in a substrate, the mold layer can be provided having a desired dielectric constant to achieve better attenuation characteristics for the antenna to meet the performance requirements for supporting higher frequencies as an example. Also, providing the antenna in mold layer may provide more flexibility to form metal layers and components therein and with the desired pitch and spacing to form the antenna that may be more difficult in the package substrate to avoid interfering with other signal routing paths therein.

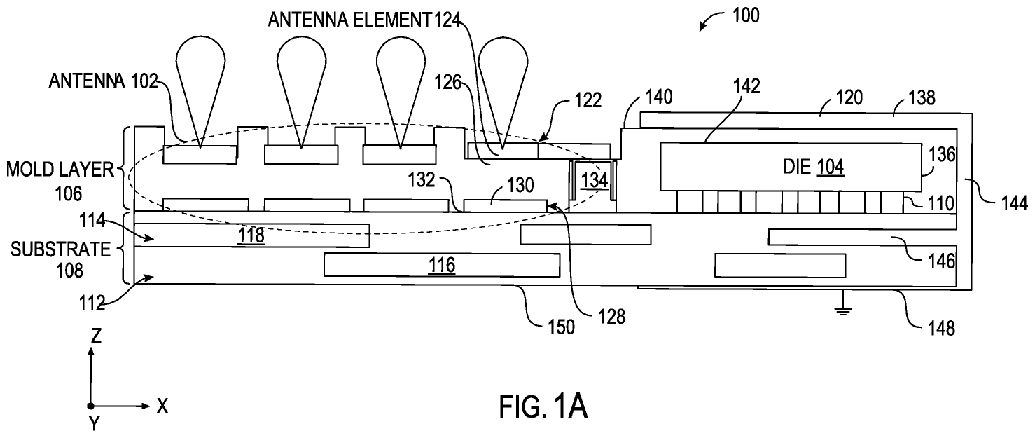

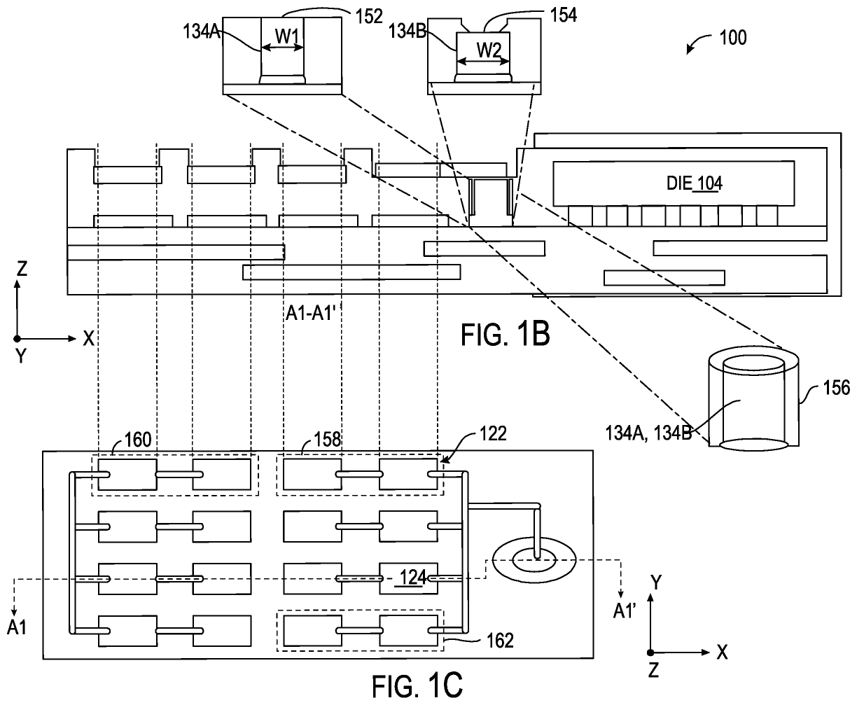

In this regard, FIG. 1A is a side view of an exemplary antenna module 100 having an antenna 102 and a die 104 in a mold layer 106 wherein the mold layer 106 has a desired dielectric constant to achieve better attenuation characteristics for the antenna 102 and wherein the antenna 102 is electrically coupled to the die 104 through an antenna substrate 108. The antenna substrate 108 extends in a first, horizontal direction(s) (X- and/or Y-axis direction(s)) and supports the antenna 102 including antenna elements (e.g., patch and/or dipole antenna elements) for supporting RF communications. The mold layer 106 includes the die 104 and is adjacent to the substrate 108 in a second, vertical direction (Z-axis direction) which is orthogonal to the first direction.

An object being “adjacent” to another object as discussed in this application relates to an object being beside, on or next to another object with intervening space between them. Adjacent objects may not be physically coupled to each other. Directly adjacent objects means that such objects are directly beside, on or next to each other without another of the objects being intervening or disposed between the directly adjacent objects. Non-directly adjacent objects means that such objects are not directly beside, on or next to each other without another of the objects being intervening or disposed between the non-directly adjacent objects.

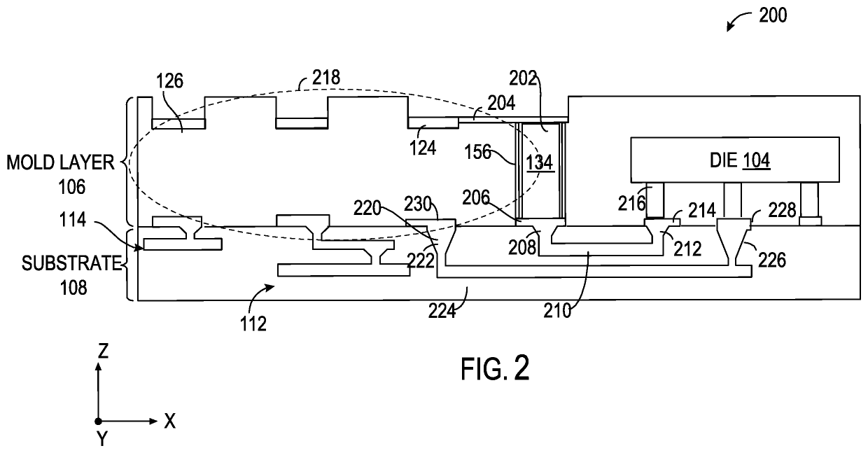

The substrate 108 also supports the die 104 which includes RF circuitry. Die interconnects 110 couple the die 104 to the substrate 108. The substrate 108 includes multiple metallization layers including metallization layer 112, metallization layer 114, and laminate insulation material therebetween. The metallization layer 112 includes metal interconnects 116 (e.g., metal traces, metal lines). The metallization layer 114 also includes metal interconnects 118 (e.g., metal traces, metal lines) and a portion of a metal shield 120. The metal interconnects 116 and 118 provide signal routing paths between the die 104 and the antenna 102. Specific electrical coupling between the die 104 and the antenna 102 will be described in connection with FIG. 2.

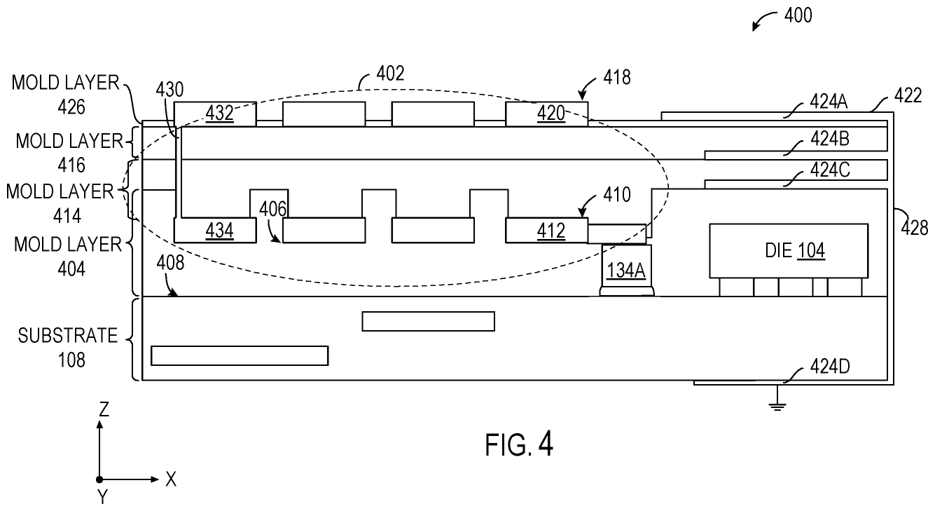

A first set of antenna elements 122 including antenna element 124 are adjacent to a first surface 126 of the mold layer 106. A second set of antenna elements 128 including antenna element 130 are adjacent to a second surface 132 of the substrate 108. The substrate 108 also supports a metal post 134 which is a portion of an antenna feed line between the antenna element 124 and the die 104. An antenna feed line is a transmission line that couples an antenna to a radio. The mold layer 106 is composed of mold compound and/or mold film whose dielectric constants can vary widely. For example, mold compound and/or mold film may have dielectric constants that can range from 2 to 40. Insulation layers in the substrate 108 include a glass weave to provide structural support to antenna module 100 which limits the dielectric constant for the insulation layer. Typical dielectric constants for insulation layers in a substrate are around 4. The mold layer 106 and especially subsequent mold layers as described in connection with FIGS. 4, 6, and 7 contain minimal, if any, glass weaves. The selection of mold compounds/films and their corresponding dielectrics provide an antenna designer to achieve better attenuation characteristics for the antenna.

The die 104 includes a sidewall 136 which extends in the second, vertical direction (Z-axis direction). The metal shield 120 includes a first metal portion 138 which extends in the first, horizontal(s) direction (X and/or Y axis direction(s)). The first metal portion 138 is adjacent to a third surface 140 of the mold layer 106, and is at least coextensive with a fourth surface 142 of the top of the die 104. The metal shield 120 also includes a second metal portion 144 which extends in the second, vertical direction (Z-axis direction). The second metal portion 144 is adjacent to the sidewall 136, and is at least coextensive with the sidewall 136 of the die 104. The metal shield 120 may also include a metal portion 146 and a metal portion 148. The metal portion 146 is formed in the metallization layer 114, and the metal portion 148 is formed adjacent to a bottom, fifth surface 150 of the substrate 108. The metal shield 120 is also coupled to ground.

In operation, RF signals are received by the first set of antenna elements 122. The first set of antenna elements 122 cooperates with the second set of antenna elements 128 depending on how each one is configured and transmitted through the metal post 134 to RF circuitry in the die 104 through the substrate 108. Similarly, RF signals are transmitted from the first set of antenna elements 122 after cooperating with the second set of antenna elements 128. For example, the antenna element 124 may be designed to cooperate with the antenna element 130 by resonating the RF signal electromagnetically through the mold layer 106.

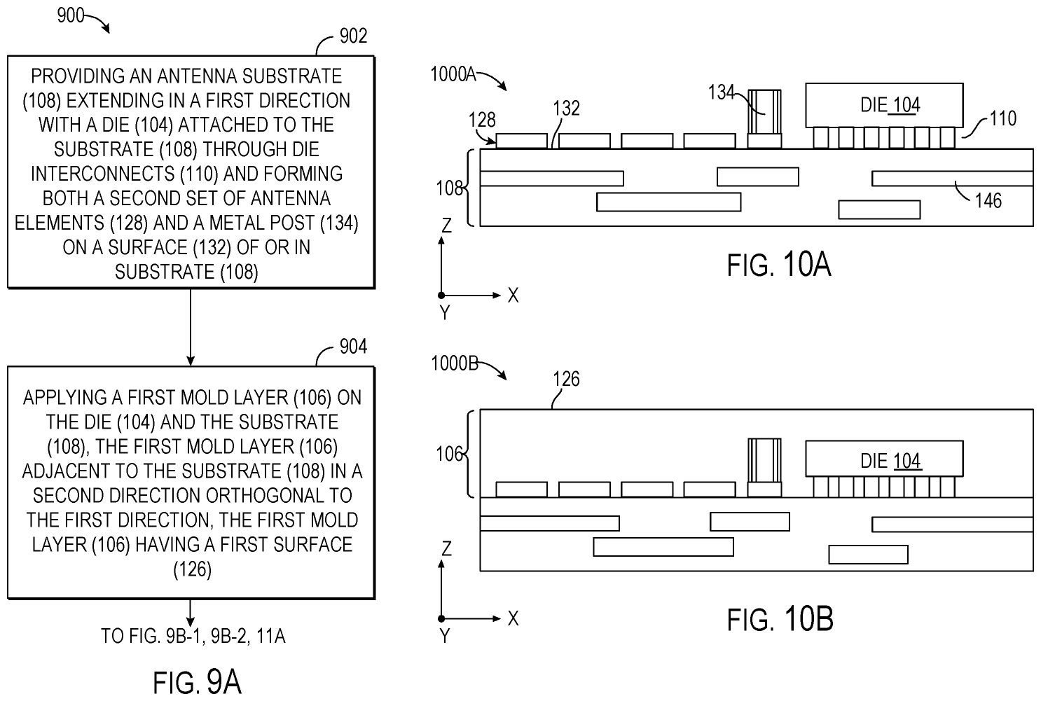

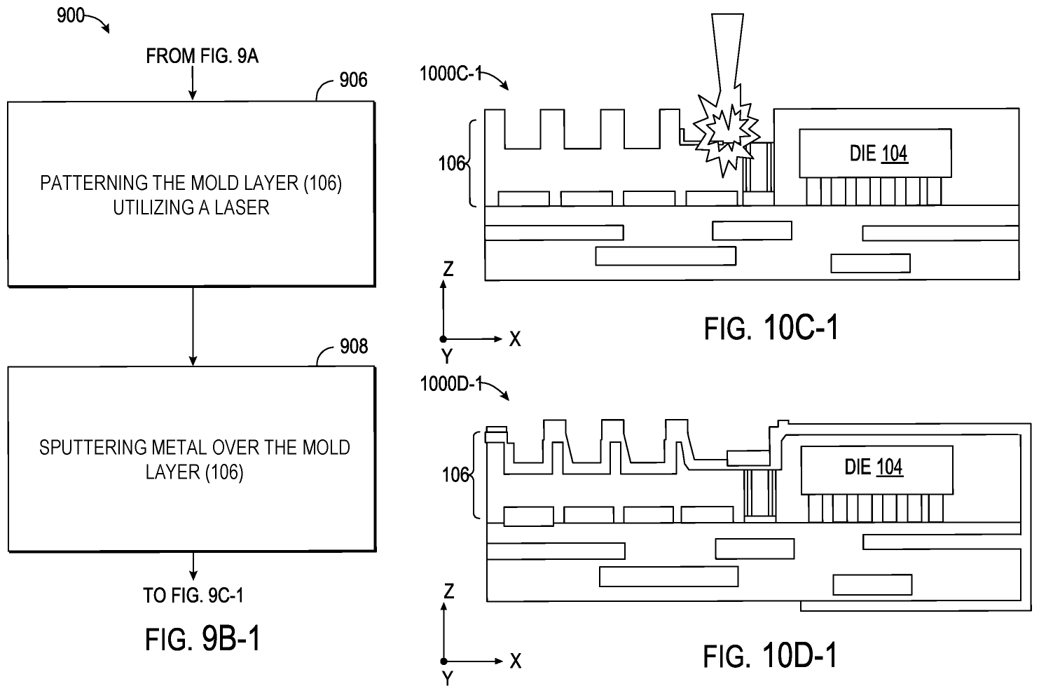

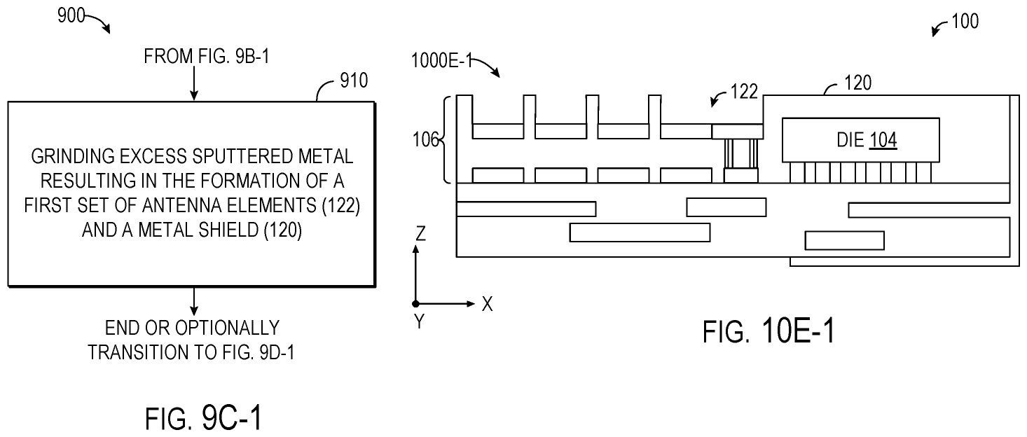

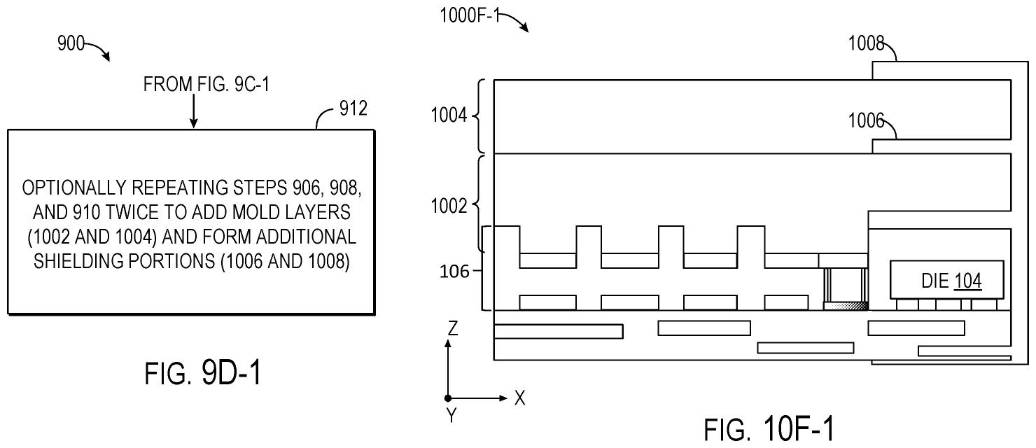

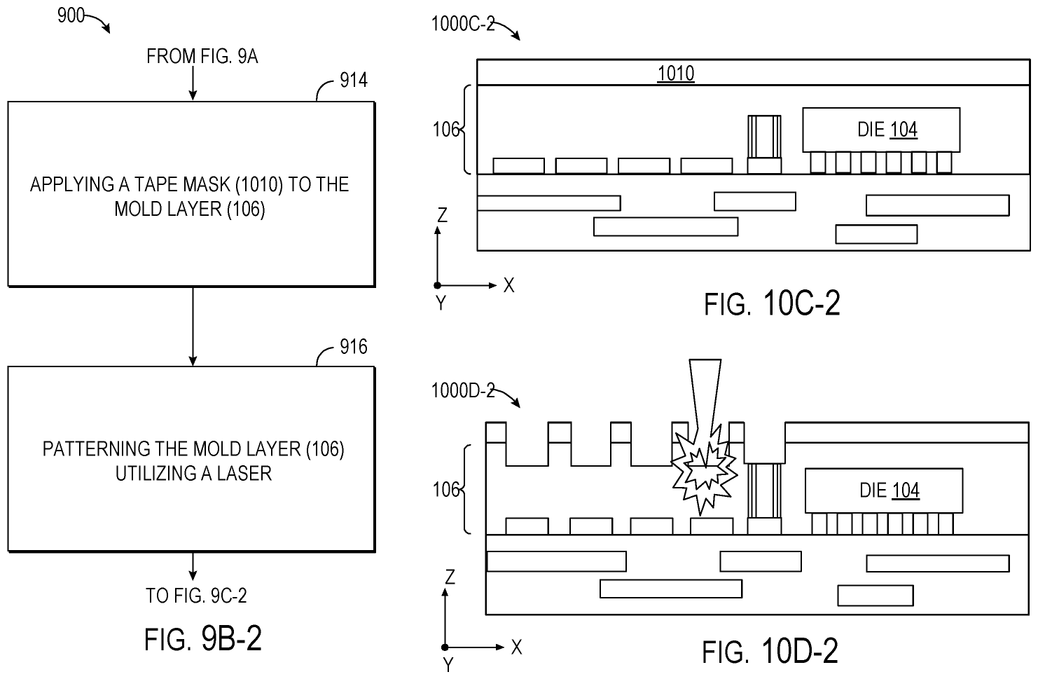

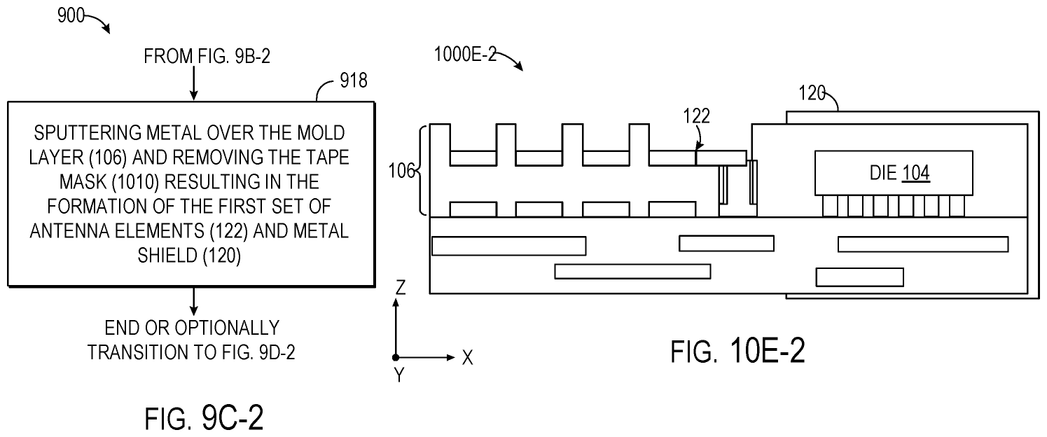

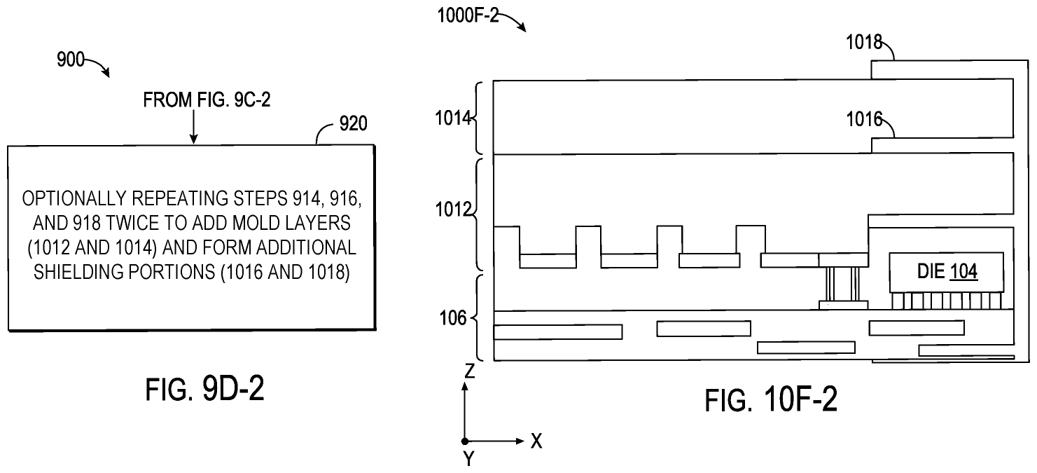

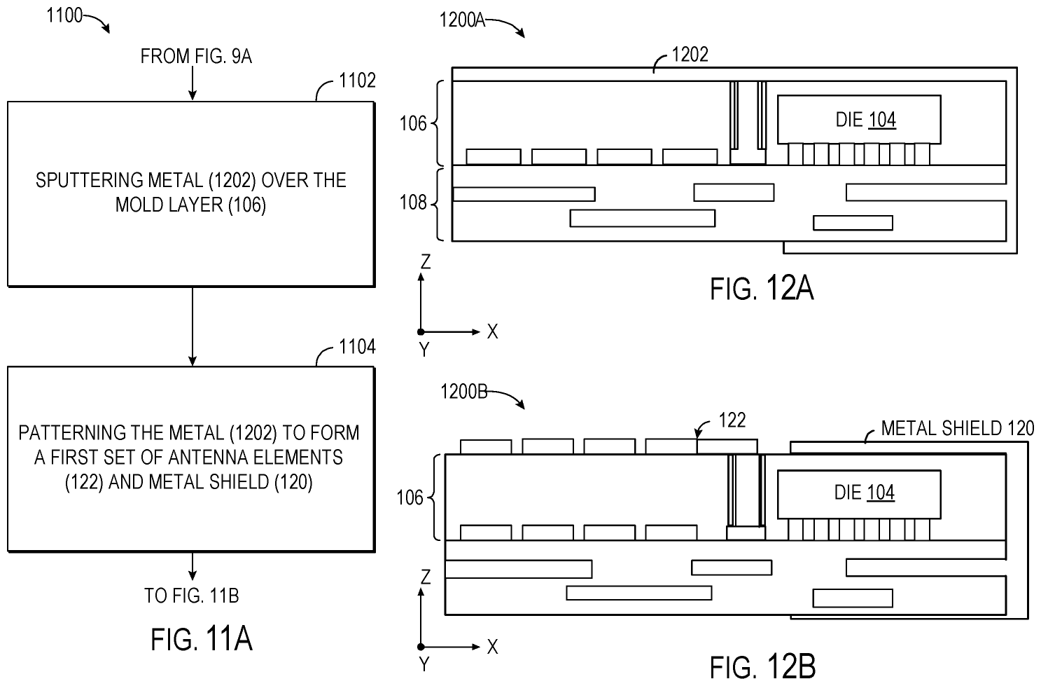

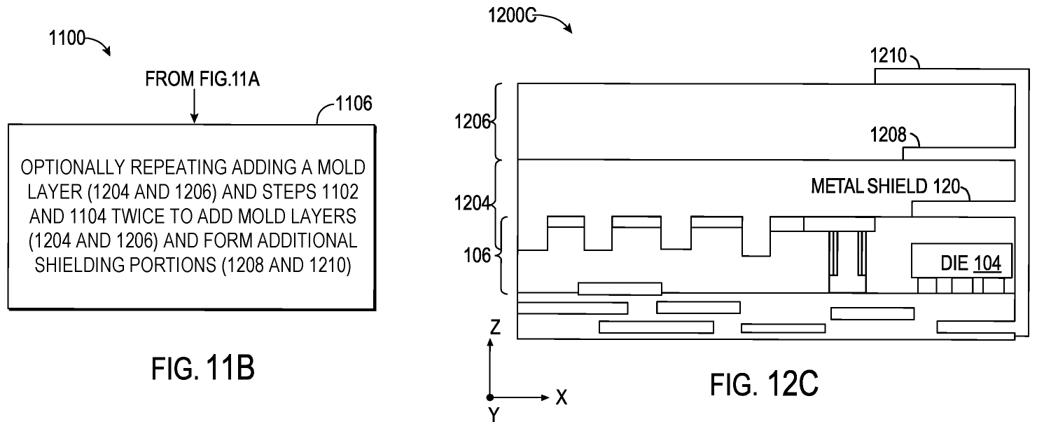

FIG. 1B is a side view of the antenna module 100 of FIG. 1A along cut lines A1-A1′ in FIG. 1C and illustrating alternative embodiments of the metal post 134 in FIG. 1A. Metal post 134A was fabricated using the mold cavity-type process that will be described in connection with FIGS. 9A-9D-2. The metal post 134A has a flat surface 152 across a width, W1, of the metal post 134A due to a grinding step described in the mold cavity-type process in connection with FIGS. 9A-9D-2. The grinding step strips excess mold compound after the mold layer 106 is dispensed onto the substrate 108. Metal post 134B has a surface 154 whose width is less than a width, W2, of the metal post 134B due to a laser described in the laser cavity-type process in connection with FIGS. 11A-11B. In short, the laser step removes excess mold compound by discharging a laser. An insulation layer 156 optionally surrounds either metal post 134A or 134B. The signal integrity of an RF signal carried through the metal post 134A or 134B may be enhanced depending on the dielectric constant of the insulation layer 156 and the wavelengths of the RF signals expected to be carried through the metal post 134A or 134B.

FIG. 1C is a top view from the Z-direction illustrating an exemplary arrangement of antenna elements in the first set of antenna elements 122 of FIG. 1. As described in FIG. 1A, the first set of antenna elements 122 is adjacent to the first surface 126 of the mold layer 106. As an example of antenna design, an antenna element pair 158 may be configured to electromagnetically couple to an antenna element pair 160. As another example, an antenna element pair 162 may be configured to electromagnetically couple to an antenna pair adjacent to the second surface 132 of the substrate 108 and below the antenna element pair 162 in the second, vertical direction (Z-direction).

FIG. 2 is a side view of another exemplary antenna module 200 having an antenna 218 and a die 104 in a mold layer 106 wherein the mold layer 106 has a desired dielectric constant to achieve better attenuation characteristics for the antenna 218 and wherein the antenna 218 is electrically coupled to the die 104 through a substrate 108 through antenna feed lines connecting the die 104 with the antenna. Common elements between the antenna module 200 and elements of the antenna module 100 in FIGS. 1A-1C are shown with common element numbers. An antenna feed line 202 includes a metal trace 204, a metal post 134, a metal interconnect 206, a metal via 208, a metal trace 210 in a metallization layer 114, a metal via 212, a metal interconnect 214, and a die connect 216. The antenna feed line 202 provides a path through the mold layer 106 to transmit and receive RF signals between the antenna 218 and RF circuitry within the die 104. An antenna feed line 220 includes a metal via 222, a metal trace 224, a metal via 226, and a metal interconnect 228. The antenna feed line 220 provides a path within the substrate 108 to transmit and receive RF signals between the antenna 218, and, in particular antenna clement 230, and RF circuitry within die 104.

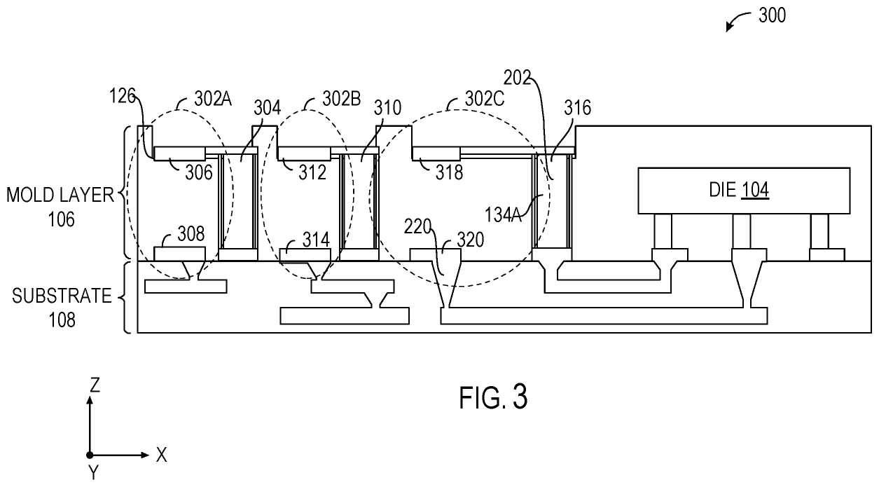

FIG. 3 is a side view of another exemplary antenna module 300 having an antenna and a die 104 in a mold layer 106 wherein the mold layer 106 has a desired dielectric constant to achieve better attenuation characteristics for the antenna and wherein antenna portions 302A, 302B, and 302C are vertically shielded between each other. Common elements between the antenna module 300 and elements of antenna modules 100 and 200 in FIGS. 1-2 are shown with common element numbers. The antenna portion 302A includes a metal post 304 as part of an antenna feed line connecting an antenna clement 306. The antenna clement 306 electromagnetically couples RF signals with an antenna element 308. The antenna portion 302A is shielded from electromagnetic waves in the antenna portion 302B by the metal post 304. The metal post 304 also shields the antenna portion 302B from electromagnetic waves in the antenna portion 302A. The antenna portion 302B includes a metal post 310 as a portion of an antenna feed line connecting to an antenna element 312. The antenna element 312 electromagnetically couples RF signals to an antenna element 314. The antenna portion 302B is shielded from electromagnetic waves in antenna portion 302A by metal post 304 and is shielded from electromagnetic waves in the antenna portion 302C by the metal post 310. The antenna portion 302C includes a metal post 316 which is a portion of an antenna feed line that connects to an antenna element 318. The antenna element 318 electromagnetically couples RF signals with an antenna element 320. The antenna portion 302C is shielded from electromagnetic waves in the die 104 by the metal post 316. The metal post 316 also shields the die 104 from electromagnetic waves in the antenna portion 302C.

FIG. 4 is a side view of another exemplary antenna module 400 having an antenna 402 and a die 104 in a mold layer 404 wherein the mold layer 404 has a desired dielectric constant to achieve better attenuation characteristics for the antenna 402 and wherein both sets of antenna elements are deployed on a respective mold layer and layers of metal shielding of a die are also deployed on respective mold layers. Common elements between the antenna module 400 and elements of the antenna modules 100, 200, and 300 in FIGS. 1-3 are shown with common element numbers. The antenna module 400 includes a substrate 108 and the mold layer 404. The mold layer 404 extends in a first, horizontal direction(s) (X- and/or Y-axis direction(s)) and has a first surface 406. The mold layer 404 is adjacent to a second surface 408 of the substrate 108 in the second, vertical direction (Z-axis direction). The mold layer 404 includes the die 104. A first set of antenna elements 410 including an antenna element 412 is adjacent in the second, vertical direction (Z-axis direction) to the first surface 406 of the mold layer 404. A mold layer 414 is adjacent in the second, vertical direction (Z-axis direction) to the mold layer 404. A mold layer 416 is adjacent in the second, vertical direction (Z-axis direction) to the mold layer 414. A second set of antenna elements 418 including an antenna element 420 is adjacent in the second, vertical direction (Z-axis direction) to the mold layer 416. The first set of antenna elements 410 electromagnetically couples with the second set of antenna elements 418 to receive and transmit RF signals to RF circuitry in the die 104.

A metal shield 422 includes metal shield portions 424A, 424B, 424C and 424D extending in the first, horizontal direction (X- and/or Y-axis direction(s)). The metal shield 422 also includes a metal shield portion 428 extending in the second, vertical direction (Z-axis direction). The metal shield portion 424A is adjacent to a mold layer 426 in the second, vertical direction (Z-axis direction). The mold layer 426 extends in the first, horizontal direction(s) (X- and/or Y-axis direction(s)). The metal shield portion 424B is adjacent in the second, vertical direction (Z-axis direction) to the mold layer 414. The metal shield portion 424C is adjacent to adjacent in the second, vertical direction (Z-axis direction) to the mold layer 404. The metal shield 422 also includes the metal shield portion 428 which extends in the second, vertical direction (Z-axis direction) and runs along at least the sidewall of the die 104. The metal shield 422 is coupled to ground. An optional metal via 430 which extends through the mold layers 416 and 414 may be utilized to electrically connect an antenna element 432 to an antenna element 434. Metal via 430 can be fabricated utilizing a laser to form a deep trench and either filling the trench with metal or sputtering metal into the trench. The mold layers 404, 414, 416. and 426 may be selected from a group of mold compounds/films that have various dielectric constants to enable an antenna designer to specifically tune the attenuation characteristics of the antenna 402 to meet RF wavelength and performance requirements.

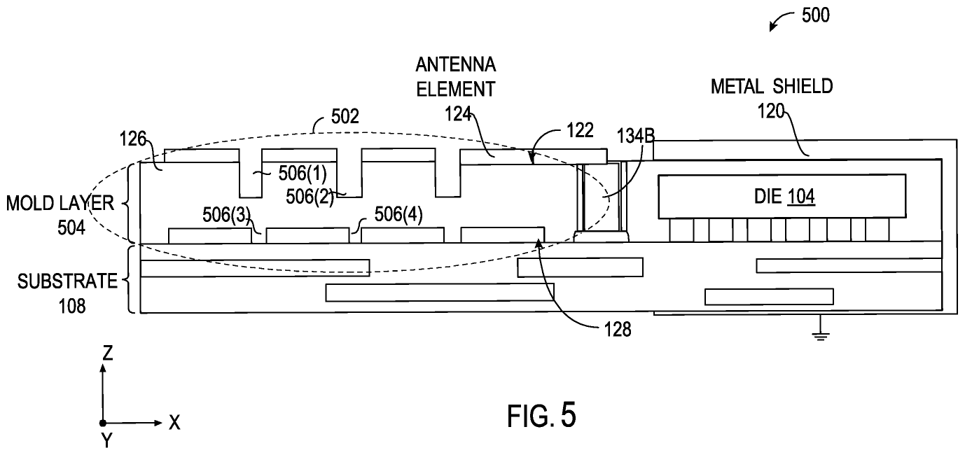

The antenna modules 100, 200, 300, and 400 are illustrated as utilizing the mold cavity-type fabrication process described in connection with FIGS. 9A-9D-2 that enables fabricating antenna elements in multiple mold layers. Functionally equivalent antenna modules may also be fabricated utilizing the mold slot-type fabrication process described in connection with FIGS. 11A-11B. FIGS. 5-7 illustrate antenna modules fabricated utilizing the mold slot-type process described in connection with FIGS. 11A-11B.

In this regard, FIG. 5 is a side view of an exemplary antenna module 500 having an antenna 502 and a die 104 in a mold layer 504 wherein the mold layer 504 has a desired dielectric constant to achieve better attenuation characteristics for the antenna 502 and is fabricated utilizing a mold slot-type process. The antenna module 500 also includes a metal shield 120 to shield the die 104. The antenna module 500 is functionally equivalent to the antenna module 100 in FIGS. 1A-1C. Common elements between the antenna module 500 and elements of the antenna module 100 in FIGS. 1A-1C are shown with common element numbers. Slots 506(1)-506(4) are created due to the mold slot-type process described in connection with FIGS. 11A-11B.

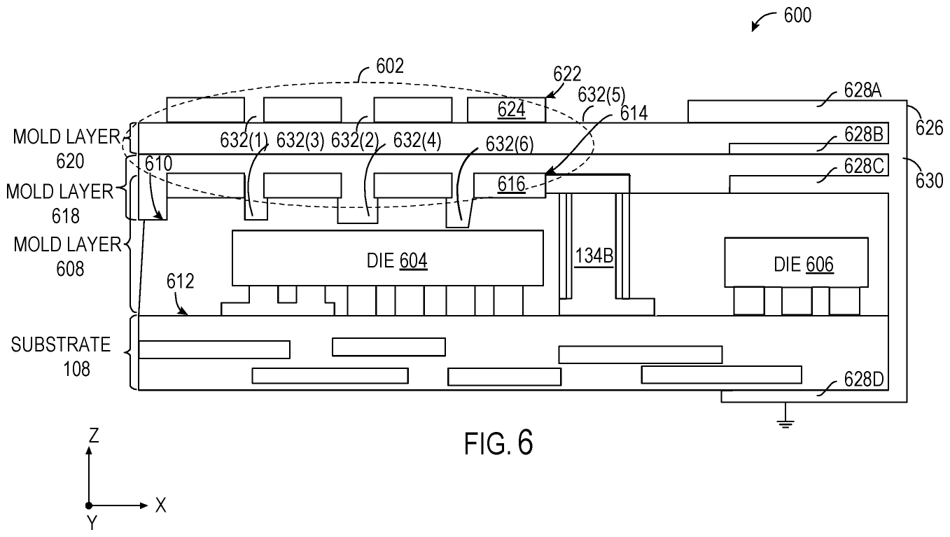

FIG. 6 is a side view of an exemplary antenna module 600 having an antenna 602 and multiple dies, die 604 and die 606 in a mold layer 608 wherein the mold layer 608 has a desired dielectric constant to achieve better attenuation characteristics for the antenna 602 and is fabricated utilizing a mold slot-type process as described in connection with FIGS. 11A-11B. Common elements between the antenna module 600 and elements of the antenna module 100 in FIGS. 1A-1C are shown with common element numbers. The mold layer 608 extends in a first, horizontal direction(s) (X- and/or Y-axis direction(s)) and has a first surface 610. The mold layer 608 is. adjacent to a second surface 612 of a substrate 108 in the second, vertical direction (Z-axis direction). The mold layer 608 includes the die 604 and the die 606. The die 604 and the die 606 include RF circuitry. A first set of antenna elements 614 including an antenna element 616 is adjacent in the second, vertical direction (Z-axis direction) to the first surface 610 of the mold layer 608. A mold layer 618 is adjacent in the second, vertical direction (Z-axis direction) to the mold layer 608. A mold layer 620 is adjacent in the second, vertical direction (Z-axis direction) to the mold layer 618. A second set of antenna elements 622 including an antenna clement 624 is adjacent in the second, vertical direction (Z-axis direction) to the mold layer 620. The first set of antenna elements 614 electromagnetically couples with the second set of antenna elements 622 to receive and transmit RF signals to RF circuitry in the dies 604 and 606.

A metal shield 626 includes metal shield portions 628A, 628B, 628C and 628D extending in the first, horizontal direction(s) (X- and/or Y-axis direction(s)). The metal shield 626 also includes a portion 630 extending in the second, vertical direction (Z-axis direction). The metal shield portion 628A is adjacent in the second, vertical direction (Z-axis direction) to the mold layer 620 and was deployed on the mold layer 620 in the same manner as the second set of antenna elements 622 utilizing a mold slot-type process that will be discussed in more detail in connection with FIGS. 11A-11B. The metal shield portion 628B is adjacent to the mold layer 618 in the second, vertical direction (Z-axis direction) and was deployed on the mold layer 618 utilizing a mold cavity-type process that will be discussed in more detail in connection with FIGS. 9A-9D-2. As shown in FIG. 6, both processes can be utilized when fabricating an antenna module. The metal shield portion 628C is adjacent in the second, vertical direction (Z-axis direction) to the mold layer 608. The metal shield portion 628C was deployed on the mold layer 608 in the same manner as the first set of antenna elements 614 utilizing the mold slot-type process described in connection with FIGS. 11A-11B. The metal shield 626 is coupled to ground. The mold layers 608, 618, and 620 may be selected from a group of mold compounds or mold films having various dielectric constants to enable an antenna designer to specifically tune the attenuation characteristics of the antenna 602 to meet RF wavelength and performance requirements.

Slots 632(1)-632(6) are created due to the mold slot-type process described in connection with FIGS. 11A-11B. As shown in FIG. 6, the slot depth of slots 632(2), 632(4), and 632(6) may vary and may either touch die 604 as shown in slot 632(6) or not touch die 604 as shown in slots 632(2) and 632(4). Please note as described above, the second set of antenna elements 622 and the metal shield portion 628A was fabricated utilizing the mold slot-type process, and the metal shield portion 628B was fabricated using the mold cavity-type process, illustrating that both process types may be deployed while fabricating the same antenna module.

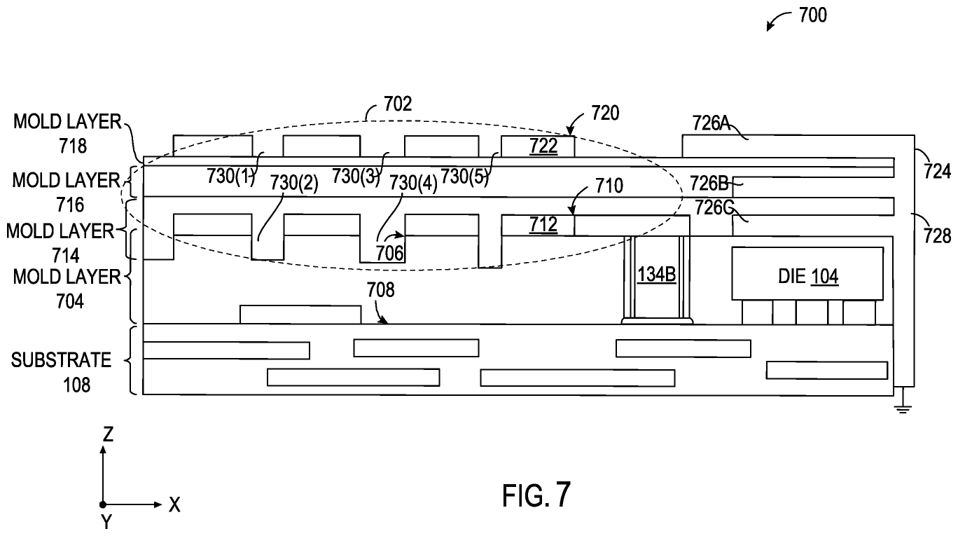

FIG. 7 is a side view of an exemplary antenna module 700 having an antenna 702 and a die 104 in a mold layer 704 wherein the mold layer 704 has a desired dielectric constant to achieve better attenuation characteristics for the antenna 702, wherein first and second sets of antenna elements 710, 720 are disposed on respective mold layers 704. 718, and fabricated utilizing a mold slot-type process. Common elements between the antenna module 700 and elements of the antenna module 100 in FIGS. 1A-1C are shown with common element numbers. The mold layer 704 extends in a first, horizontal direction(s) (X- and/or Y-axis direction(s)) and has a first surface 706. The mold layer 704 is adjacent to a second surface 708 of a substrate 108 in the second, vertical direction (Z-axis direction). The mold layer 704 includes the die 104. A first set of antenna elements 710, including an antenna clement 712, is adjacent in the second, vertical direction (Z-axis direction) to the first surface 706 of the mold layer 704. A mold layer 714 is adjacent in the second, vertical direction (Z-axis direction) to the mold layer 704. A mold layer 716 is adjacent in the second, vertical direction (Z-axis direction) to the mold layer 714. A mold layer 718 is adjacent in the second, vertical direction (Z-axis direction) to the mold layer 716. A second set of antenna elements 720 including an antenna element 722 is adjacent in the second, vertical direction (Z-axis direction) to the mold layer 718. The first set of antenna elements 710 electromagnetically couples with the second set of antenna elements 720 to receive and transmit RF signals to RF circuitry in the die 104.

A metal shield 724 includes metal shield portions 726A, 726B, and 726C extending in the first, horizontal direction(s) (X- and/or Y-axis direction(s)). The metal shield 724 also includes a portion 728 extending in the second, vertical direction (Z-axis direction). The metal shield portion 726A is adjacent in the second, vertical direction (Z-axis direction) to the mold layer 718 and was deployed on the mold layer 718 in the same manner as the second set of antenna elements 720 utilizing a mold slot-type process that will be discussed in more detail in connection with FIGS. 11A-11B. The metal shield portion 726B is adjacent to the mold layer 714 in the second, vertical direction (Z-axis direction) and was deployed in the mold layer 716 utilizing a mold cavity-type process. The metal shield portion 726C is adjacent in the second, vertical direction (Z-axis direction) to the mold layer 704. The metal shield portion 726C was deployed on the mold layer 704 in the same manner as the first set of antenna elements 710. Metal shield portion 728 is formed at the same time as metal shield portion 726A by sputtering metal utilizing a 3::1 thickness ratio. For example, the width of metal shield 726A may be 3 micrometers (μm) in the Z-direction while the width of metal shield 730 is 1 μm in the X-direction. The metal shield 724 is coupled to ground. The mold layers 704, 714, 716 and 718 may be selected from a group of mold compounds/films having various dielectric constants to enable an antenna designer to specifically tune the attenuation characteristics of the antenna 702 to meet RF wavelength and performance requirements. Slots 730(1)-730(5) are created due to the mold slot-type process described in connection with FIGS. 11A-11B.

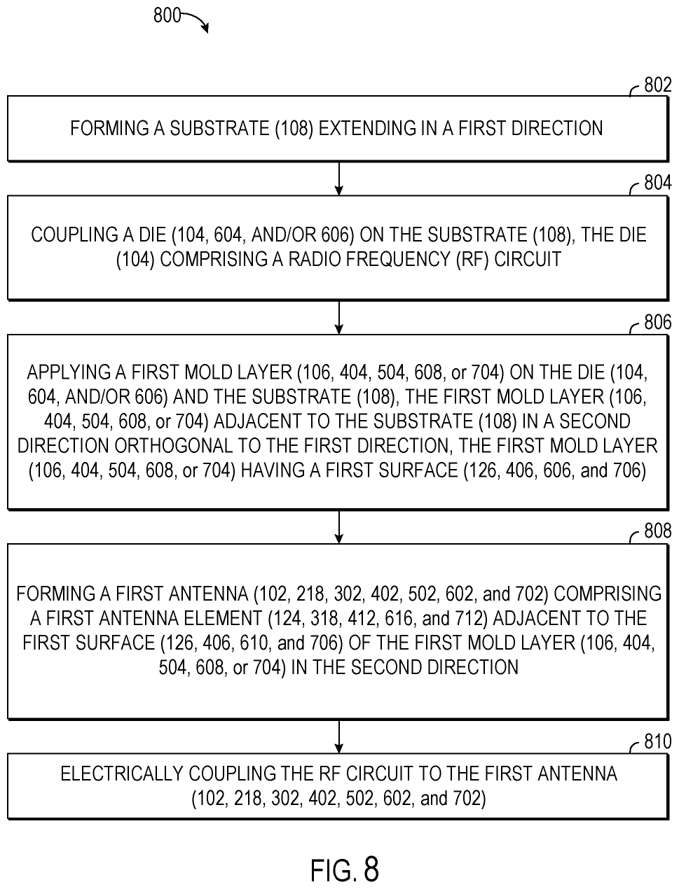

An antenna module that includes an antenna and a die in a mold layer wherein the mold layer(s) has a desired dielectric constant to achieve better attenuation characteristics for the antenna, including, but not limited to, the antenna modules 100, 200, 300, 400, 500, 600, and 700 in FIGS. 1A-7 can be fabricated by different fabrication processes. FIG. 8 is a flowchart illustrating an exemplary fabrication process 800 for fabricating an antenna module having an antenna and a die in a mold layer wherein the mold layer has a desired dielectric constant to achieve better attenuation characteristics for the antenna, including, but not limited to, the antenna modules 100, 200, 300, 400, 500, 600, and 700 in FIGS. 1A-7.

In this regard, a first exemplary step in the fabrication process 800 of FIG. 8 can include forming a substrate 108 extending in a first direction (block 802, FIG. 8). A next step in the fabrication process 800 can include coupling a die 104, 604, and/or 606 on the substrate 108, the die comprising an RF circuit (block 804 in FIG. 8). A next step in the fabrication process 800 can include applying a first mold layer 106, 404, 504, 608, or 704 on the die 104, 604, 606 and the substrate 108, the first mold layer 106, 404, 504, 608, or 704 adjacent to the substrate 108 in a second direction orthogonal to the first direction, the first mold layer 106, 404, 504, 608, or 704 having a first surface 126, 406, 610, and 706 (block 806 in FIG. 8). A next step in the fabrication process 800 can include forming a first antenna 102, 218, 302, 402, 502, 602, and 702 comprising a first antenna clement 124, 318, 412, 616, and 712 adjacent to the first surface 126, 406, 610, and 706 of the first mold layer 106, 404, 504, 608, or 704 in the second direction (block 808 in FIG. 8). A next step in the fabrication process 800 can include electrically coupling the RF circuit to the first antenna 102, 218, 302, 402, 502, 602, and 702 (block 810 in FIG. 8).

Other fabrication processes can also be employed to fabricate an antenna module having an antenna and a die in a mold layer wherein the mold layer has a desired dielectric constant to achieve better attenuation characteristics for the antenna, including, but not limited to, the antenna modules 100, 200, 300, 400, 500, 600, and 700 in FIGS. 1A-7 can be fabricated by different fabrication processes. In this regard, FIGS. 9A-9D is a flowchart illustrating an exemplary mold cavity-type fabrication process for fabricating an antenna module having an antenna and a die in a mold layer wherein the mold layer has a desired dielectric constant to achieve better attenuation characteristics for the antenna, including, but not limited to, the antenna modules 100, 200, 300, and 400 in FIGS. 1A-4. FIGS. 10A-10F-2 are exemplary fabrication stages during fabrication of the antenna module according to the mold cavity-type fabrication process in FIGS. 9A-9D. The fabrication process 900 as shown in the fabrication stages 1000A-1000F-2 in FIGS. 10A-10F-2 are in reference to the antenna module 100 in FIG. 1A, and thus will be discussed with reference to the antenna module 100 in FIG. 1A.

In this regard, as shown at fabrication stage 1000A in FIG. 10A, an exemplary step in the fabrication process 900 is providing an antenna substrate 108 extending in a first direction with a die 104 attached to the substrate 108 through die interconnects 110 and forming both a second set of antenna elements 128 and a metal post 134 on a surface 132 of or in the substrate 108 (block 902 in FIG. 9A). The substrate 108 may include a metal portion 146 of an eventual metal shield formed in a metallization layer 114. The second set of antenna elements 128 and the base of the metal post 134 may be formed utilizing known techniques including copper plating, copper sputtering, or embedded tracing. The metal post 134 is formed by a solder mount technology (SMT) process.

As shown at fabrication stage 1000B in FIG. 10B, a next step in the fabrication process 900 can include applying a first mold layer 106 on the die 104 and the substrate 108, the first mold layer 106 adjacent to the substrate 108 in a second direction orthogonal to the first direction, the first mold layer 106 having a first surface 126 (block 904 in FIG. 9A). From this step, two alternatives within the mold cavity-type fabrication process 900 will be described. The first alternative includes FIGS. 9B-1. 9C-1, and 9D-1 and corresponding fabrication stages 1000C-1, 1000D-1, 1000E-1, 1000F-1 in FIGS. 10C-1, 10D-1, 10E-1, and 10F-1. The second alternative includes FIGS. 9B-2, 9C-2, and 9D-2 and corresponding fabrication stages 1000C-2, 1000D-2, 1000E-2, 1000F-2 in FIGS. 10C-2, 10D-2, 10E-2, and 10F-2.

As shown at fabrication stage 1000C-1 in FIG. 10C-1, a next step in the fabrication process 900 can include patterning the mold layer 106 utilizing a laser (block 906 in FIG. 9B-1). As shown at fabrication stage 1000D-1 in FIG. 10D-1, a next step in the fabrication process 900 can include sputtering metal over the pattern on the mold layer 106 (block 908 in FIG. 9B-1) and down the sidewall of the antenna module 100. The sputtered metal can be, but is not limited to, copper, aluminum, silver, or gold. Metal shield 120 is formed by sputtering metal generally utilizing a 3::1 ratio between metal sputtered in the X, Y direction to form metal shield portion 138 and metal sputtered in the Z direction to form metal shield portion 144. As shown at fabrication stage 1000E-1 in FIG. 10E-1, a next step in the fabrication process 900 can include grinding excess metal from the pattern resulting in the formation of a first set of antenna elements 122 and a metal shield 120 (block 910 in FIG. 9C-1). At this point in the process 900, the antenna module 100 is formed. An optional step 912 may be performed to add additional levels of shielding. Steps 906, 908, and 910 may be repeated one or more times to form a set of antenna elements on another mold layer, electrically coupling in the second, vertical direction (Z-axis direction) antenna elements on different mold layers, or to add additional shielding. As shown at fabrication stage 1000F-1 in FIG. 10F-1, a next step in the fabrication process 900 can include optionally repeating steps 906, 908, and 910 twice to add mold layers 1002 and 1004 and form additional shielding portions 1006 and 1008 (block 912 in FIG. 9D-1).

The second alternative begins at block 914 in FIG. 9B-2. As shown at fabrication stage 1000C-2 in FIG. 10C-2, a next step in the fabrication process 900 can include applying a tape mask 1010 to the mold layer 106 (block 914 in FIG. 9B-2). As shown at fabrication stage 1000D-2 in FIG. 10D-2, a next step in the fabrication process 900 can include patterning the mold layer 106 utilizing a laser (block 916 in FIG. 9B-2). As shown at fabrication stage 1000E-2 in FIG. 10E-2, a next step in the fabrication process 900 can include sputtering metal over the pattern on the mold layer 106 and removing the tape mask 1010 resulting in the formation of the first set of antenna elements 122 and the metal shield 120 (block 918 in FIG. 9C-2). Utilizing the tape mask 1010 avoids the grinding step in the first alternative. An optional block 920 may be performed to add additional levels of shielding. Steps 914, 916, and 918 may be repeated one or more times to form a set of antenna elements on another mold layer, electrically coupling in the second, vertical direction (Z-axis direction) antenna elements on different mold layers, or to add additional shielding. As shown at fabrication stage 1000F-2 in FIG. 10F-2, a next step in the fabrication process 900 can include optionally repeating steps 914. 916, and 918 twice to add mold layers 1012 and 1014 and form additional shielding portions 1016 and 1018 (block 920 in FIG. 9D-2).

Other fabrication processes can also be employed to fabricate an antenna module having an antenna and a die in a mold layer wherein the mold layer has a desired dielectric constant to achieve better attenuation characteristics for the antenna, including, but not limited to, the antenna modules 100, 200, 300, 400, 500, 600, and 700 in FIGS. 1-7 can be fabricated by different fabrication processes. In this regard, FIGS. 11A-11B is a flowchart illustrating an exemplary mold slot-type fabrication process 1100 for fabricating an antenna module having an antenna and a die in a mold layer wherein the mold layer has a desired dielectric constant to achieve better attenuation characteristics for the antenna, including, but not limited to, the antenna modules 500, 600, and 700 in FIGS. 5-7. FIGS. 12A-12C are exemplary fabrication stages 1200A-1200C during fabrication of the antenna module according to the mold slot-type fabrication process 1100 in FIGS. 11A-11B. The fabrication process 1100 as shown in the fabrication stages 1200A-1200C in FIGS. 12A-12C is in reference to the antenna module 500 in FIG. 5, and thus will be discussed with reference to the antenna module 500.

In this regard, the mold slot-type fabrication process 1100 follows after block 904 in FIG. 9A. As shown at fabrication stage 1200A in FIG. 12A, a first step in the fabrication process 1100 can include sputtering metal 1202 over the mold layer 106 (block 1102 in FIG. 11A). As shown at fabrication stage 1200B in FIG. 12B, a next step in the fabrication process 1100 can include patterning the metal 1202 to form a first set of antenna elements 122 and a metal shield 120 (block 1104 in FIG. 11A). Patterning the metal 1202 in block 1104 may be performed by a laser or by an etch stop process. As shown at fabrication stage 1200C in FIG. 12C, a next step in the fabrication process 1100 can include optionally repeating adding a mold layer steps 1102 and 1104 twice to add mold layers 1204 and 1206 and form additional shielding portions 1208 and 1210 (block 1106 in FIG. 11B).

The antenna module having an antenna and multiple die(s) in a mold layer wherein the mold layer has a desired dielectric constant to achieve better attenuation characteristics, including, but not limited to, the antenna modules 100, 200, 300, 400, 500, 600, and 700 in FIGS. 1A-7, and according to the exemplary fabrication and assembly processes in FIGS. 8-12C, and according to aspects disclosed herein may be provided in or integrated into any processor-based device or wireless device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

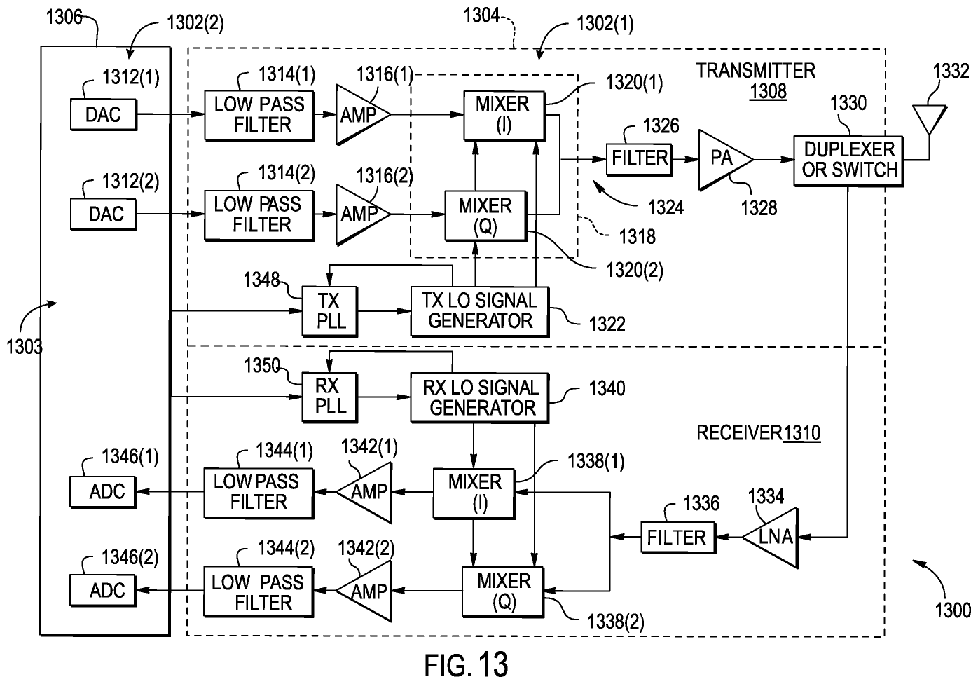

In this regard, FIG. 13 illustrates an exemplary wireless communications device 1300 that includes radio frequency (RF) components formed from one or more ICs 1302, wherein any of the ICs 1302 can include an antenna module having an antenna and die(s) in a mold layer wherein the mold layer has a desired dielectric constant to achieve better attenuation characteristics, and according to any aspects disclosed herein. The wireless communications device 1300 may include or be provided in any of the above-referenced devices, as examples. As shown in FIG. 13, the wireless communications device 1300 includes a transceiver 1304 and a data processor 1306. The data processor 1306 may include a memory to store data and program codes. The transceiver 1304 includes a transmitter 1308 and a receiver 1310 that support bi-directional communications. In general, the wireless communications device 1300 may include any number of transmitters 1308 and/or receivers 1310 for any number of communication systems and frequency bands. All or a portion of the transceiver 1304 may be implemented on one or more analog ICs, RF ICs (RFICs), mixed-signal ICs, etc.

The transmitter 1308 or the receiver 1310 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage in receiver 1310. In the direct-conversion architecture, a signal is frequency-converted between RF and baseband in one stage. The super-heterodyne and direct-conversion architectures may use different circuit blocks and/or have different requirements. In the wireless communications device 1300 in FIG. 13, the transmitter 1308 and the receiver 1310 are implemented with the direct-conversion architecture.

In the transmit path, the data processor 1306 processes data to be transmitted and provides I and Q analog output signals to the transmitter 1308. In the exemplary wireless communications device 1300, the data processor 1306 includes digital-to-analog converters (DACs) 1312(1), 1312(2) for converting digital signals generated by the data processor 1306 into I and Q analog output signals, e.g., I and Q output currents, for further processing.

Within the transmitter 1308, lowpass filters 1314(1), 1314(2) filter the I and Q analog output signals, respectively, to remove undesired signals caused by the prior digital-to-analog conversion. Amplifiers (AMPs) 1316(1), 1316(2) amplify the signals from the lowpass filters 1314(1), 1314(2), respectively, and provide I and Q baseband signals. An upconverter 1318 upconverts the I and Q baseband signals with I and Q transmit (TX) local oscillator (LO) signals from a TX LO signal generator 1322 through mixers 1320(1), 1320(2) to provide an upconverted signal 1324. A filter 1326 filters the upconverted signal 1324 to remove undesired signals caused by the frequency upconversion as well as noise in a receive frequency band. A power amplifier (PA) 1328 amplifies the upconverted signal 1324 from the filter 1326 to obtain the desired output power level and provides a transmit RF signal. The transmit RF signal is routed through a duplexer or switch 1330 and transmitted via an antenna 1332.

In the receive path, the antenna 1332 receives signals transmitted by base stations and provides a received RF signal, which is routed through the duplexer or switch 1330 and provided to a low noise amplifier (LNA) 1334. The duplexer or switch 1330 is designed to operate with a specific receive (RX)-to-TX duplexer frequency separation, such that RX signals are isolated from TX signals. The received RF signal is amplified by the LNA 1334 and filtered by a filter 1336 to obtain a desired RF input signal. Downconversion mixers 1338 (1), 1338 (2) mix the output of the filter 1336 with I and Q RX LO signals (i.e., LO_I and LO_Q) from an RX LO signal generator 1340 to generate I and Q baseband signals. The I and Q baseband signals are amplified by AMPs 1342(1), 1342(2) and further filtered by lowpass filters 1344(1), 1344(2) to obtain I and Q analog input signals, which are provided to the data processor 1306. In this example, the data processor 1306 includes analog-to-digital converters (ADCs) 1346(1), 1346(2) for converting the analog input signals into digital signals to be further processed by the data processor 1306.

In the wireless communications device 1300 of FIG. 13, the TX LO signal generator 1322 generates the I and Q TX LO signals used for frequency upconversion, while the RX LO signal generator 1340 generates the I and Q RX LO signals used for frequency downconversion. Each LO signal is a periodic signal with a particular fundamental frequency. A TX phase-locked loop (PLL) circuit 1348 receives timing information from the data processor 1306 and generates a control signal used to adjust the frequency and/or phase of the TX LO signals from the TX LO signal generator 1322. Similarly, an RX PLL circuit 1350 receives timing information from the data processor 1306 and generates a control signal used to adjust the frequency and/or phase of the RX LO signals from the RX LO signal generator 1340.

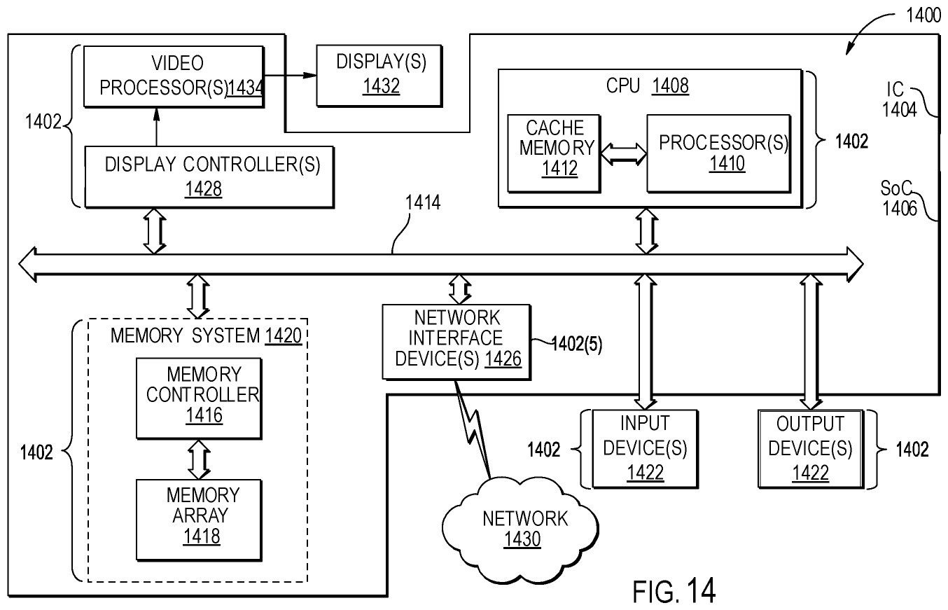

Regarding exemplary processor-based devices, FIG. 14 illustrates an example of a processor-based system 1400 that includes circuits that can be provided in IC packages 1402, 1402(1)-1402(7). Any of the IC packages 1402, 1402(1)-1402(7) which may communicate wirelessly can include an antenna module having an antenna and a die(s) in a mold layer wherein the mold layer has a desired dielectric constant to achieve better attenuation characteristics, including, but not limited to, the antenna modules 100, 200, 300, 400, 500, 600, and 700 in FIGS. 1A-7, and according to the exemplary fabrication and assembly processes in FIGS. 8-12C, and according to any aspects disclosed herein. In this example, the processor-based system 1400 may be formed as an IC 1404 in an IC package 1402 and as a system-on-a-chip (SoC) 1406. The processor-based system 1400 includes a central processing unit (CPU) 1408 that includes one or more processors 1410, which may also be referred to as CPU cores or processor cores. The CPU 1408 may have cache memory 1412 coupled to the CPU 1408 for rapid access to temporarily stored data. The CPU 1408 is coupled to a system bus 1414 and can intercouple master and slave devices included in the processor-based system 1400. As is well known, the CPU 1408 communicates with these other devices by exchanging address, control, and data information over the system bus 1414. For example, the CPU 1408 can communicate bus transaction requests to a memory controller 1416, as an example of a slave device. Although not illustrated in FIG. 14, multiple system buses 1414 could be provided, wherein each system bus 1414 constitutes a different fabric.

Other master and slave devices can be connected to the system bus 1414. As illustrated in FIG. 14, these devices can include a memory system 1420 that can be in a separate IC package 1402(4) and that includes the memory controller 1416 and a memory array(s) 1418, one or more input devices 1422 (that can be in a separate IC package 1402(6)), one or more output devices 1424 (that can be in a separate IC package 1402(7)), one or more network interface devices 1426 (that can be in a separate IC package 1402(5)), and one or more display controllers 1428 (that can be in a separate IC package 1402(2)), as examples. Each of the memory system 1420, the one or more input devices 1422, the one or more output devices 1424, the one or more network interface devices 1426, and the one or more display controllers 1428 can be provided in the same or different IC packages 1402(5). The input device(s) 1422 can include any type of input device, including, but not limited to, input keys, switches, voice processors, etc. The output device(s) 1424 can include any type of output device, including, but not limited to, audio, video, other visual indicators, etc. The network interface device(s) 1426 can be any device configured to allow exchange of data to and from a network 1430. The network 1430 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1426 can be configured to support any type of communications protocol desired.

The CPU 1408 may also be configured to access the display controller(s) 1428 over the system bus 1414 to control information sent to one or more displays 1432. The display controller(s) 1428 sends information to the display(s) 1432 to be displayed via one or more video processors 1434, which process the information to be displayed into a format suitable for the display(s) 1432. The display controller(s) 1428 and video processor(s) 1434 can be included as ICs in the same or different IC packages 1402(5), and in the same or different IC package 1402(1) containing the CPU 1408, as an example. The display(s) 1432 can include any type of display, including, but not limited to, a cathode ray tube (CRT), a liquid crystal display (LCD), a plasma display, a light emitting diode (LED) display, etc.

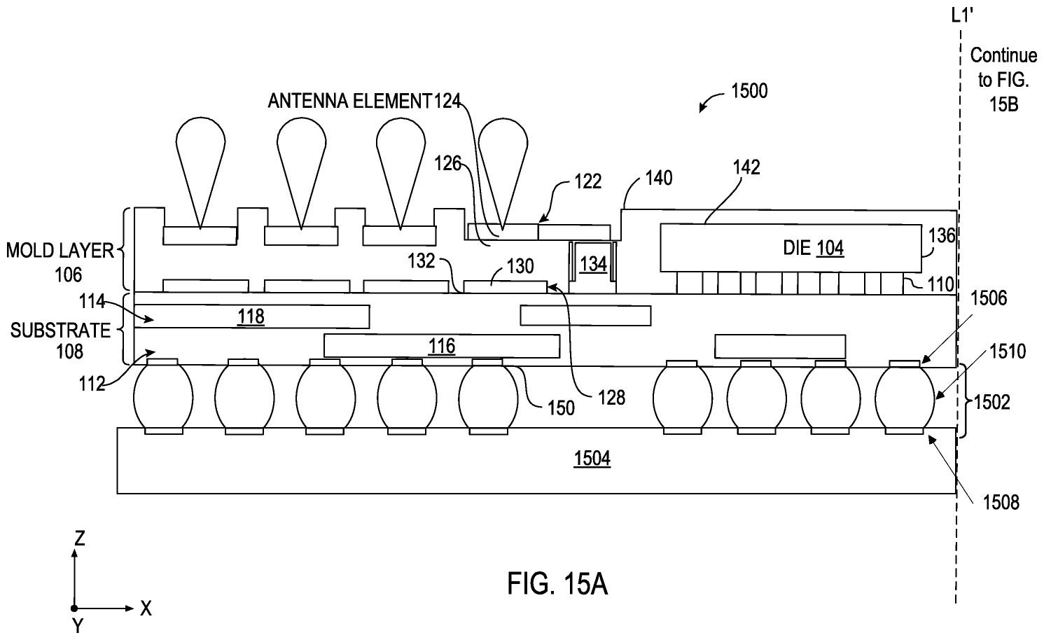

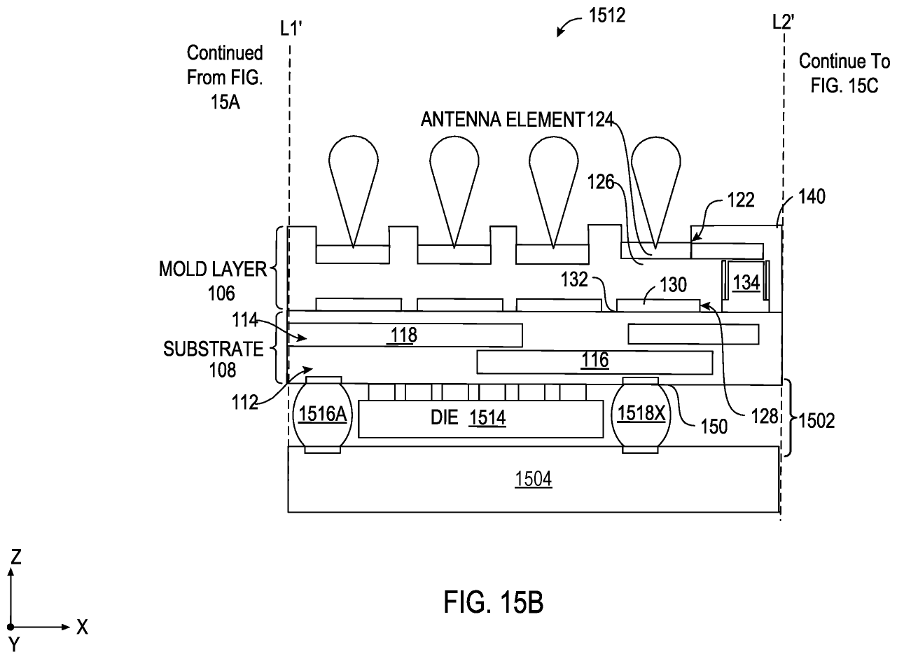

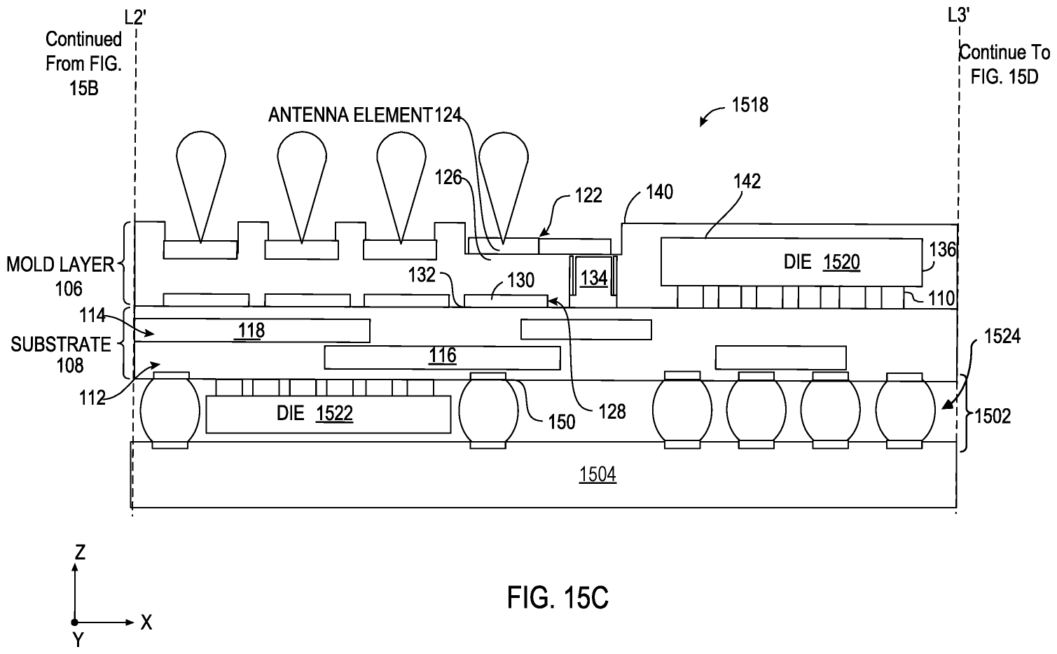

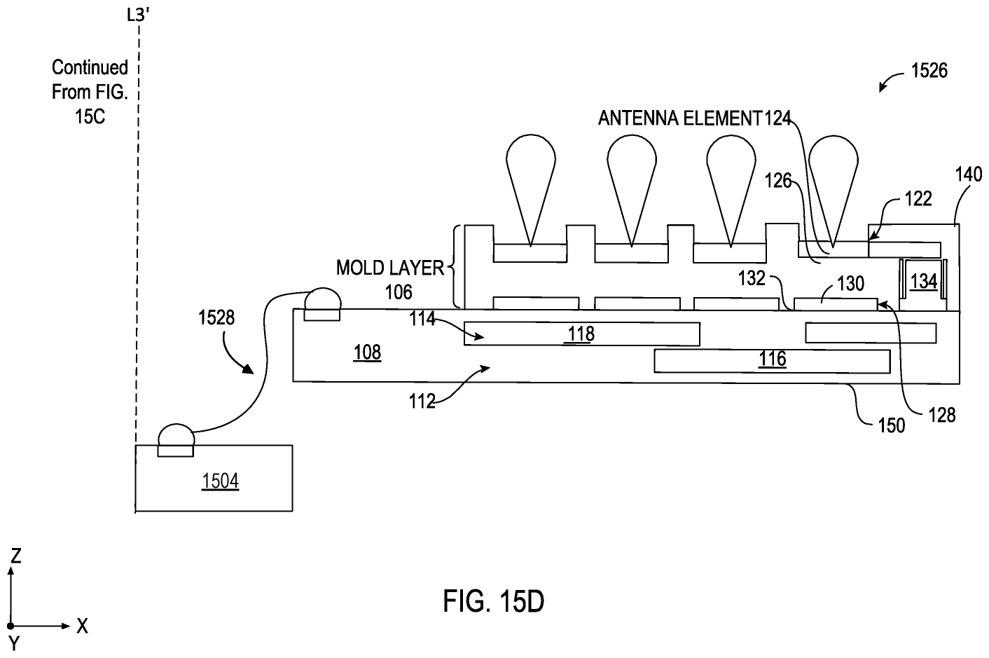

FIGS. 15A-15D are block diagrams of exemplary deployments of antenna modules having an antenna in a mold layer on a printed circuit board wherein the mold layer has a desired dielectric constant to achieve better attenuation characteristics for the antenna including, but not limited to, the antenna modules in FIGS. 1A-7 and according to, but not limited to, any of the exemplary fabrication processes in FIGS. 8, 9A-9D-2, and 11A-11B. FIGS. 15A, 15B, 15C, and 15D illustrate individual exemplary deployments that are shown deployed on the same printed circuit board. Each exemplary deployment can be deployed separately on a printed circuit board or in combination with any other exemplary deployment on the same printed circuit board. Common elements between the antenna modules in FIGS. 15A-15D and elements of the antenna module 100 in FIGS. 1A-1C are shown with common element numbers.

FIG. 15A is a portion up to cut line L1′ and illustrates deployment of antenna module 1500. Antenna module 1500 includes solder ball layer 1502 and printed circuit board 1504. Solder ball layer 1502 includes metal interconnects 1506 and metal interconnects 1508 and solder balls 1510 to electrically couple die 104 to printed circuit board 1504.

FIG. 15B is a portion between cut line L1′ and cut line L2′ and illustrates deployment of antenna module 1512. Solder ball layer 1502 between cut lines L1′ and L2′ also includes die 1514 and solder balls 1516A . . . 1516X. Solder balls 1516A . . . 1516X electrically couple die 1514 to printed circuit board 1504. Die 1514 electrically couples to antenna elements 122 and 128 through metal interconnects 116 and 118.

FIG. 15C is a portion between cut line L2′ and cut line L3′ and illustrates deployment of antenna module 1518. Mold layer 106 includes die 1520. Solder ball layer 1502 between cut lines L1′ and L2′ also includes die 1522 and solder balls 1524. Solder balls 1524 electrically couple dies 1520 and 1522 to printed circuit board 1504. Die 1522 electrically couples to antenna elements 122 and 128 through metal interconnects 116 and 118 and to die 1520. Die 1522 electrically couples to antenna elements 122 and 128 through metal interconnects 116 and 118.

FIG. 15D is a portion beginning at cut line L3′ and illustrates deployment of antenna module 1526. Antenna module 1526 is formed in mold layer 106 and electrically couples to printed circuit board 1504 through a flex connection 1528 and to any one or more of the dies 1520, 1522, 1514, and 104 through the printed circuit board 1504.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

Implementation examples are described in the following numbered clauses:

1. An antenna module, comprising:
a substrate extending in a first direction;
a die comprising a radio-frequency (RF) circuit, the die disposed on the substrate;
a first mold layer including the die and adjacent to the substrate in a second direction orthogonal to the first direction, the first mold layer having a first surface; and
a first antenna comprising a first antenna element adjacent to the first surface of the first mold layer in the second direction, the RF circuit electrically coupled to the first antenna.
   2. The antenna module of clause 1, wherein:
the first antenna further comprises:
   a second antenna element coupled to the first antenna element, wherein the second antenna element is adjacent to a second surface of the substrate; and
the antenna module further comprises:
   an antenna feed line coupled to the first antenna and the RF circuit.
      3. The antenna module of clause 1, further comprising:
an antenna feed line; and
a second mold layer adjacent to the first antenna element in the second direction, wherein the first antenna further comprises:
   a second antenna element adjacent to the second mold layer in the second direction and coupled to the first antenna element, wherein the antenna feed line is coupled to the first antenna and the RF circuit.
      4. The antenna module of clause 2, wherein the antenna feed line is coupled to the second antenna element through the substrate.
      5. The antenna module of clause 3, wherein the antenna feed line comprises a metal post coupling the RF circuit to the first antenna element.
      6. The antenna module of clause 3, further comprising:
a via in the second mold layer electrically coupled to the first antenna element and the second antenna element.
   7. The antenna module of clause 1, wherein:
the die comprises:
   a sidewall extending in the second direction; and
the antenna module further comprises:
   a first metal shield comprising:
      a first metal portion adjacent to a third surface of the first mold layer, extending in the first direction and adjacent to the die in the second direction, and at least coextensive with a fourth surface of the die; and
      a second metal portion adjacent to the sidewall of the die and at least coextensive with the sidewall of the die.
         8. The antenna module of clause 7, wherein the second metal portion is configured to be coupled to ground.
         9. The antenna module of clause 7, further comprising:
a second mold layer adjacent to the first metal portion of the first metal shield; and
a second metal shield, comprising:
   a first metal portion adjacent to the second mold layer extending in the first direction and coextensive with the first metal portion of the first metal shield; and
   a second metal portion extending in the second direction, the second metal portion of the second metal shield coupled to the first metal portion of the second metal shield and the second metal portion of the first metal shield.
      10. The antenna module of clause 1, wherein the first antenna further comprises:
a second antenna element coupled to the first antenna element and adjacent to the first surface of the first mold layer.
   11. The antenna module of clause 1, further comprising:
an antenna feed line coupled to the first antenna and the RF circuit, wherein the first antenna is configured to radiate RF signals.
   12. The antenna module of clause 3, wherein the second antenna element is configured to electromagnetically couple RF signals with the first antenna element.
   13. The antenna module of clause 1 integrated into a device selected from a group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics systems; a drone; and a multicopter.
   14. A method of fabricating an antenna module, comprising:
forming a substrate extending in a first direction;
coupling a die on the substrate, the die comprising a radio-frequency (RF) circuit;
applying a first mold layer on the die and the substrate, the first mold layer adjacent to the substrate in a second direction orthogonal to the first direction, the first mold layer having a first surface;
forming a first antenna comprising a first antenna element adjacent to the first surface of the first mold layer in the second direction; and
electrically coupling the RF circuit to the first antenna.
   15. The method of clause 14, further comprising:
forming a second antenna element coupled to the first antenna element, wherein the second antenna element is adjacent to a second surface of the substrate, and
coupling an antenna feed line to the first antenna and the RF circuit.
   16. The method of clause 14, further comprising:
forming an antenna feed line;
forming a second mold layer adjacent to the first antenna element in the second direction;
forming a second antenna element adjacent to the second mold layer in the second direction and coupled to the first antenna element; and
coupling the antenna feed line to the first antenna and the RF circuit.
   17. The method of clause 15, wherein coupling the antenna feed line to the first antenna and the RF circuit further comprises:
coupling the antenna feed line to the second antenna element through the substrate.
   18. The method of clause 16, wherein forming the antenna feed line comprises:
forming a metal post; and
coupling the metal post to the RF circuit and the first antenna element.
   19. The method of clause 16, further comprising:
forming a via in the second mold layer; and
electrically coupling the first antenna element and the second antenna element through the via.
   20. The method of clause 14, further comprising:
forming a first metal shield comprising:
   a first metal portion on a third surface of the first mold layer extending in the first direction and adjacent to the die in the second direction, and at least coextensive with a fourth surface of the die; and
   a second metal portion adjacent to a sidewall of the die extending in the second direction and coextensive with the sidewall of the die.
      21. The method of clause 20, further comprising:
coupling the second metal portion to ground.
   22. The method of clause 20, further comprising:
forming a second mold layer adjacent to the first metal portion of the first metal shield; and
forming a second metal shield, comprising:
   a first metal portion on the second mold layer extending in the first direction and adjacent to the first metal portion of the first metal shield in the second direction and coextensive with the first metal portion of the first metal shield; and
   a second metal portion extending in the second direction, the second metal portion of the second metal shield coupled to the first metal portion of the second metal shield and the second metal portion of the first metal shield.
      23. The method of clause 14, wherein forming the first antenna comprising the first antenna element adjacent to the first surface of the first mold layer in the second direction comprises:
patterning on the first mold layer;
sputtering metal on the first mold layer; and
grinding excess sputtered metal forming the first antenna comprising the first antenna element adjacent to the first surface of the first mold layer in the second direction.
   24. The method of clause 23, wherein grinding the excess sputtered metal further comprises:
forming a metal shield, shielding the die from electromagnetic signals.
   25. The method of clause 24, further comprising:
applying a second mold layer to the antenna module;
patterning on the second mold layer;
a over the second mold layer; and
grinding excess metal forming a second metal shield portion adjacent to the second mold layer in the second direction.
   26. The method of clause 14, wherein forming the first antenna comprising the first antenna element adjacent to the first surface of the first mold layer in the second direction comprises:
applying a tape mask to the first mold layer;
patterning the first mold layer;
sputtering metal over the first mold layer; and
removing the tape mask from the first mold layer.
   27. The method of clause 14, wherein forming the first antenna comprising the first antenna element adjacent to the first surface of the first mold layer in the second direction comprises:
sputtering a metal over the first mold layer; and
patterning the metal to form the first antenna comprising the first antenna element adjacent to the first surface of the first mold layer in the second direction.
   28. The method of clause 27, wherein patterning the metal further comprises:
forming a metal shield adjacent to the first surface of the first mold layer,
wherein the method further comprises:
   applying a second mold layer to the antenna module;
   sputtering a second metal over the second mold layer; and
   patterning the second metal to form a second metal shield portion adjacent to the second mold layer in the second direction.

What is claimed is:

1. An antenna module, comprising:
a substrate extending in a first direction;
a die comprising a radio-frequency (RF) circuit, the die disposed on the substrate;
a first mold layer including the die and adjacent to the substrate in a second direction orthogonal to the first direction, the first mold layer having a first surface; and
a first antenna comprising a first antenna element adjacent to the first surface of the first mold layer in the second direction, the RF circuit electrically coupled to the first antenna.

2. The antenna module of claim 1, wherein:
the first antenna further comprises:
a second antenna element coupled to the first antenna element, wherein the second antenna element is adjacent to a second surface of the substrate; and
the antenna module further comprises:
an antenna feed line coupled to the first antenna and the RF circuit.

3. The antenna module of claim 1, further comprising:
an antenna feed line; and
a second mold layer adjacent to the first antenna element in the second direction, wherein the first antenna further comprises:
a second antenna element adjacent to the second mold layer in the second direction and coupled to the first antenna element,
wherein the antenna feed line is coupled to the first antenna and the RF circuit.

4. The antenna module of claim 2, wherein the antenna feed line is coupled to the second antenna element through the substrate.

5. The antenna module of claim 3, wherein the antenna feed line comprises a metal post coupling the RF circuit to the first antenna element.

6. The antenna module of claim 3, further comprising:
a via in the second mold layer electrically coupled to the first antenna element and the second antenna element.

7. The antenna module of claim 1, wherein:
the die comprises:
a sidewall extending in the second direction; and
the antenna module further comprises:
a first metal shield comprising:
a first metal portion adjacent to a third surface of the first mold layer, extending in the first direction and adjacent to the die in the second direction, and at least coextensive with a fourth surface of the die; and
a second metal portion adjacent to the sidewall of the die and at least coextensive with the sidewall of the die.

8. The antenna module of claim 7, wherein the second metal portion is configured to be coupled to ground.

9. The antenna module of claim 7, further comprising:
a second mold layer adjacent to the first metal portion of the first metal shield; and
a second metal shield, comprising:
a first metal portion adjacent to the second mold layer extending in the first direction and coextensive with the first metal portion of the first metal shield; and
a second metal portion extending in the second direction, the second metal portion of the second metal shield coupled to the first metal portion of the second metal shield and the second metal portion of the first metal shield.

10. The antenna module of claim 1, wherein the first antenna further comprises:
a second antenna element coupled to the first antenna element and adjacent to the first surface of the first mold layer.

11. The antenna module of claim 1, further comprising:
an antenna feed line coupled to the first antenna and the RF circuit, wherein the first antenna is configured to radiate RF signals.

12. The antenna module of claim 3, wherein the second antenna element is configured to electromagnetically couple RF signals with the first antenna element.

13. The antenna module of claim 1 integrated into a device selected from a group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics systems; a drone; and a multicopter.

14. A method of fabricating an antenna module, comprising:
forming a substrate extending in a first direction;
coupling a die on the substrate, the die comprising a radio-frequency (RF) circuit;
applying a first mold layer on the die and the substrate, the first mold layer adjacent to the substrate in a second direction orthogonal to the first direction, the first mold layer having a first surface;
forming a first antenna comprising a first antenna element adjacent to the first surface of the first mold layer in the second direction; and
electrically coupling the RF circuit to the first antenna.

15. The method of claim 14, further comprising:
forming a second antenna element coupled to the first antenna element, wherein the second antenna element is adjacent to a second surface of the substrate, and
coupling an antenna feed line to the first antenna and the RF circuit.

16. The method of claim 14, further comprising:
forming an antenna feed line;
forming a second mold layer adjacent to the first antenna element in the second direction;
forming a second antenna element adjacent to the second mold layer in the second direction and coupled to the first antenna element; and
coupling the antenna feed line to the first antenna and the RF circuit.

17. The method of claim 15, wherein coupling the antenna feed line to the first antenna and the RF circuit further comprises:
coupling the antenna feed line to the second antenna element through the substrate.

18. The method of claim 16, wherein forming the antenna feed line comprises:
forming a metal post; and
coupling the metal post to the RF circuit and the first antenna element.

19. The method of claim 16, further comprising:
forming a via in the second mold layer; and
electrically coupling the first antenna element and the second antenna element through the via.

20. The method of claim 14, further comprising:
forming a first metal shield comprising:
a first metal portion on a third surface of the first mold layer extending in the first direction and adjacent to the die in the second direction, and at least coextensive with a fourth surface of the die; and
a second metal portion adjacent to a sidewall of the die extending in the second direction and coextensive with the sidewall of the die.

21. The method of claim 20, further comprising:
coupling the second metal portion to ground.

22. The method of claim 20, further comprising:
forming a second mold layer adjacent to the first metal portion of the first metal shield; and
forming a second metal shield, comprising:
a first metal portion on the second mold layer extending in the first direction and adjacent to the first metal portion of the first metal shield in the second direction and coextensive with the first metal portion of the first metal shield; and
a second metal portion extending in the second direction, the second metal portion of the second metal shield coupled to the first metal portion of the second metal shield and the second metal portion of the first metal shield.

23. The method of claim 14, wherein forming the first antenna comprising the first antenna element adjacent to the first surface of the first mold layer in the second direction comprises:
patterning on the first mold layer;
sputtering metal on the first mold layer; and
grinding excess sputtered metal forming the first antenna comprising the first antenna element adjacent to the first surface of the first mold layer in the second direction.

24. The method of claim 23, wherein grinding the excess sputtered metal further comprises:
forming a metal shield, shielding the die from electromagnetic signals.

25. The method of claim 24, further comprising:
applying a second mold layer to the antenna module;
patterning on the second mold layer;
a over the second mold layer; and
grinding excess metal forming a second metal shield portion adjacent to the second mold layer in the second direction.

26. The method of claim 14, wherein forming the first antenna comprising the first antenna element adjacent to the first surface of the first mold layer in the second direction comprises:
applying a tape mask to the first mold layer;
patterning the first mold layer;
sputtering metal over the first mold layer; and
removing the tape mask from the first mold layer.

27. The method of claim 14, wherein forming the first antenna comprising the first antenna element adjacent to the first surface of the first mold layer in the second direction comprises:
sputtering a metal over the first mold layer; and
patterning the metal to form the first antenna comprising the first antenna element adjacent to the first surface of the first mold layer in the second direction.

28. The method of claim 27, wherein patterning the metal further comprises:
forming a metal shield adjacent to the first surface of the first mold layer,
wherein the method further comprises:
applying a second mold layer to the antenna module;
sputtering a second metal over the second mold layer; and
patterning the second metal to form a second metal shield portion adjacent to the second mold layer in the second direction.
